(19) United States
(12) Patent Application Publication
(10) Pub. No.: US 2022/0242442 A1
(43) Pub. Date: Aug. 4, 2022

(54) DRIVE TRAJECTORY SYSTEM AND DEVICE

(71) Applicants: JOHN S. MCNEELY, SACKETS HARBOR, NY (US); KEVIN MACVITTIE, AUSTIN, TX (US); BRIAN KAUSLER, ISLAND CITY, OR (US); GEORGE S. SMITH, II, SACKETS HARBOR, NY (US)

(72) Inventors: JOHN S. MCNEELY, SACKETS HARBOR, NY (US); KEVIN MACVITTIE, AUSTIN, TX (US); BRIAN KAUSLER, ISLAND CITY, OR (US); GEORGE S. SMITH, II, SACKETS HARBOR, NY (US)

(21) Appl. No.: 17/166,936

(22) Filed: Feb. 3, 2021

(51) Int. Cl. B60W 60/00; G07C 5/08; G06K 9/62; B60W 50/14

(52) U.S. Cl. CPC B60W 60/001; G07C 5/085; B60W 2050/146; B60W 50/14; B60W 2554/4049; G06K 9/6278

(57) ABSTRACT

A process and system for calculating drive trajectories for use by connected and autonomous vehicles (CAVs), the data used and/or produced by the system, and a device for use in calculating such drive trajectories. Location data of a pavement segment is obtained and used to calculate a polynomial representation of a drive trajectory that can be used by CAVs to navigate the pavement segment. The process and system may be used, for example, to assist CAVs in navigating areas where the normal vehicle path has been altered, such as a work zone; or under conditions of reduced visibility; or to define areas to be avoided by CAVs, such as a stationary vehicle. The present application is further directed to a process, system, and device for placing and removing markings on or adjacent to pavement segments that may be used to provide data for such use by CAVs.

### BACKGROUND

Because human drivers typically rely on visual cues and observations in order to control a vehicle, transportation infrastructures are built accordingly, with indicators such as pavement markings, traffic signs, and traffic lights all designed to provide visual information to drivers. In view of these design characteristics of transportation infrastructures, an autonomous vehicle may include a camera and a processing unit that analyzes visual information captured from the environment adjacent the vehicle. The visual information may include, for example, components of the transportation infrastructure such as pavement markings, traffic signs, and traffic lights, as well as obstacles such as other vehicles, pedestrians, and debris. An autonomous vehicle may also use stored information, such as information that provides a model of the vehicle's travel environment when navigating. For example, the vehicle may use Global Positioning Satellite (GPS) data; data from sensors such as an accelerometer, a speed sensor, or a suspension sensor; and/or other map data to provide information related to its environment while it is traveling, and the vehicle (as well as other vehicles) may use the information to localize itself on the model.

As technology continues to advance, fully autonomous vehicles able to navigate from a starting point to a destination without human control may be introduced. Autonomous vehicles may need to take into account a variety of factors and make appropriate decisions based on those factors to safely and accurately reach an intended destination. For example, an autonomous vehicle may need to process and interpret visual information (such as information captured from a camera) and may also use information obtained from other sources (such as a GPS device, a speed sensor, an accelerometer, or a suspension sensor). At the same time, in order to navigate to a destination an autonomous vehicle may also need to identify its location within a particular pavement segment, including a roadway, bike path, or runway; navigate alongside or in relation to other vehicles; avoid obstacles and humans; observe traffic markings, signals, and signs; and travel from one pavement segment to another at appropriate transition points.

### SUMMARY

In one respect, the present application is directed to a process for representing the location of a pavement segment. The process may use a mobile platform, which may be equipped with a pavement segment alignment module. In the process, a data collection system receives location data from a Global Navigation Satellite System (“GNSS”) module and from at least on additional position sensor.

Location data from the GNSS module and the at least one additional position sensor is used to calculate a location of a pavement segment alignment module. The location of the pavement segment alignment module is used to calculate a location of the pavement segment. The location of the pavement segment is used to calculate, using non-Euclidean geometry, a polynomial representation of a trajectory that can be used by a connected and autonomous vehicle in navigating the pavement segment.

The pavement segment alignment module may then be aligned with a pavement segment, and the data collection system may be activated to initiate calculation of the location of the pavement segment and of the polynomial representation of a trajectory that can be used by a connected and autonomous vehicle in navigating the pavement segment. At least one of (a) the location of the pavement segment and (b) the polynomial representation of a navigation trajectory may be transmitted to non-transitory computer-readable storage media.

In the present process, the at least one additional position sensor may be at least one of a real-time kinetic system, an inertial measurement unit, an inertial navigation system, a total station system, an accelerometer, a gyroscope, and a rotary encoder.

The pavement segment may have at least a first edge, and the location of the pavement segment may include the location of the first edge. The pavement segment may have at least a second edge, and the location of the pavement segment may include the location of the second edge. The trajectory may be calculated as a midpoint between the first edge and the second edge of the pavement segment.

The present process may calculate the trajectory as an offset from the first edge of the pavement segment, and may use a Bayesian model-based filter to calculate the location of the pavement segment.

The non-transitory computer-readable storage media to which at least one of the location of the pavement segment and the polynomial representation of a navigation trajectory is transmitted may be in a server remote from the mobile platform; alternatively, the non-transitory computer-readable storage media may be located in a connected and autonomous vehicle.

Calculation of the location of the pavement segment and of the polynomial representation of a trajectory that can be used by a connected and autonomous vehicle in navigating the pavement segment may take place concurrently with the collection of location data; alternatively, the calculation may take place subsequent to the collection of location data; and, the calculation may be made without the use of data from an imager.

In another embodiment, the present disclosure is directed to a process for navigating a connected and autonomous vehicle along a pavement segment. This process includes transmitting a signal causing a navigation system on the connected and autonomous vehicle to compare version information for trajectory data for navigating the pavement segment stored in the navigation system, to version information for trajectory data for navigating the pavement segment contained in the signal. If the comparison of version information indicates that the version of trajectory data provided in the signal is more recent than the version of trajectory data stored in the navigation system, the navigation system is provided with updated trajectory data corresponding to the version information contained in the signal. The updated trajectory data may be processed to generate a heads-up display provided on a windshield of the connected and autonomous vehicle.

The connected and autonomous vehicle uses the updated trajectory data to navigate the connected and autonomous vehicle along the pavement segment. The updated trajectory data may be processed by the navigation system for autonomous navigation.

The connected and autonomous vehicle navigation system may receive real-time navigation data from sensors on the connected and autonomous vehicle. The navigation system may compare the real-time navigation data with updated trajectory data provided as described above, and use the real-time navigation data to change the trajectory of the connected and autonomous vehicle from the trajectory provided by the updated trajectory data. The connected and autonomous vehicle may transmit the real-time navigation data used to change the trajectory of the connected and autonomous vehicle from the trajectory provided by the updated trajectory data, to non-transitory computer-readable storage media remote from the connected and autonomous vehicle.

### BRIEF DESCRIPTION OF THE DRAWINGS

FIG. 1 is a representative block diagram of a connected/autonomous vehicle;

FIG. 2 is a representative block diagram of a connected/autonomous vehicle system;

FIG. 3 is a diagrammatic representation of exemplary CAV control systems;

FIG. 4 is a representative flow chart showing calculation of a smooth-line vector;

FIG. 5 is another representative flow chart showing calculation of a smooth-line vector;

FIG. 6 is a representative flow chart showing use of VMX data by a connected/autonomous vehicle;

FIG. 7 is a representation of the use of monocular image analysis for navigation by a connected/autonomous vehicle;

FIG. 8 is a representative block diagram of the use of monocular image analysis for navigation by a connected/autonomous vehicle;

FIG. 9 is a representative sparse map for providing CAV navigation;

FIG. 10 representative block diagram of a remote server configuration for communicating, storing, and/or processing VMX data;

FIG. 11 is an example of polynomial representation of portions of a road segment;

FIG. 12 is an example of polynomial representations of trajectories;

FIG. 13 is an example of target trajectories along a multi-lane road;

FIG. 14 is another example of target trajectories along a multi-lane road;

FIG. 15 is a representative schematic illustration of a system using crowd sourcing data from a plurality of vehicles for CAV navigation;

FIG. 16 is a representation of work zone setup and configuration;

FIG. 17 is another representation of work zone setup and configuration;

FIG. 18 is a representative flow chart showing capture of VMX data during creation of a work zone;

FIG. 19 is a representative diagram showing hub beacons and CAV trajectories for navigation of a CAV through a work zone;

FIG. 20 is a representative flow chart showing removal and placement of markings in a VMX data system;

FIG. 21 is a depiction of a mobile platform for material marking;

FIG. 22 is a depiction of an alternative mobile platform for material marking;

FIG. 23 is a depiction of another alternative mobile platform for material marking;

FIG. 24 is a depiction of another alternative mobile platform for material marking;

FIG. 25 is a depiction of another alternative mobile platform for material marking;

FIG. 26 is a depiction of a mobile platform for material removal;

FIG. 27 is a depiction of another alternative mobile platform for material marking;

FIG. 28 is a representative block diagram of a device for use in collecting VMX data relating to markings; and

FIG. 29 is a representative flow chart showing a process for pavement segment modification using VMX data;

FIG. 30 is a representative flow chart showing a process for capturing and storing VMX data regarding existing or virtual marking;

FIG. 31 is a top perspective view representing use of a geofence around a stopped vehicle; and,

FIG. 32 is a top perspective view representing use of a geofence around two stopped vehicles.

### DETAILED DESCRIPTION

The following detailed description describes various features and functions of the disclosed systems, devices, and methods with reference to the accompanying figures. In the figures, similar symbols identify similar components unless context dictates otherwise. The illustrative system, device, and method embodiments described herein are not meant to be limiting. It may be readily understood that certain aspects of the disclosed systems, devices, and methods can be arranged and combined in a wide variety of different configurations and employed for uses other than those specifically described herein, all of which fall within the present scope.

### 1. Definitions

For purposes of the present disclosure:

An “autonomous” vehicle is a vehicle with the capability to change speed and/or direction without input by a human operator. An autonomous vehicle may be fully autonomous, meaning that it can navigate from an origin to a destination without human input, or partially autonomous, meaning that it may require some human input to navigate from an origin to a destination. A fully autonomous vehicle may also have a mode or modes in which it can be partially or entirely operated by a human driver, and a partially autonomous vehicle may also have a mode or modes in which it can be entirely operated by a human driver. Autonomous vehicles therefore include those that can accept or may require driver control in certain environments, and be fully autonomous in others. Autonomous vehicles may also include vehicles that are never fully autonomous, and instead control only some aspects of vehicle navigation, such as steering to maintain a vehicle course between vehicle lane constraints, but leave other aspects to the driver, such as braking or stopping. In some cases, autonomous vehicles may handle some or all aspects of braking, speed control, and/or steering of the vehicle.

A “connected” vehicle is a vehicle capable of at least receiving navigation data from an external source. A connected vehicle may also be capable of transmitting navigation data to an external location.

“Connected/autonomous Vehicle”, “CAV”, and “connected and autonomous vehicle” each encompass vehicles that are autonomous, vehicles that are connected, and vehicles that are both autonomous and connected.

“Drive vector” means a trajectory that may be characterized in terms of direction and magnitude, i.e., speed or velocity.

“Pavement” means any surface used or for use by powered and/or unpowered vehicles including but not limited to automobiles, trucks, vans, motorcycles, motorized three-wheel vehicles including those commonly referred to as “tuk tuks”, scooters, and bicycles, and so includes asphalt, concrete, oil and stone, gravel, brick, paving stones, cobblestone, dirt, and shells. Pavement does not, however, include ground having natural or cultivated flora present thereupon, such as lawns or fields including but not limited to agricultural fields.

“Markings” and “pavement markings” means any permanent or temporary marking on a pavement segment intended to provide navigational information for use by vehicle-mounted sensors and/or a vehicle driver. Such markings may include, but are not limited to, roadway markings such as edge and center line markings, symbols (such as arrows and bar codes), and alphanumeric characters including letters and words (such as STOP or SLOW); parking lot markings such as travel lane lines, parking stall/space lines, and handicapped parking space markings; markings on bicycle lanes or paths; and other markings on pavement.

“Mobile platform” means an apparatus whose design includes the ability to move or be moved by a motive force, which may be provided by an internal combustion, diesel, or electric motor or engine; by hydraulic or pneumatic mechanisms; by air propulsion such as that provided by a propeller, fan, or rotor; or by any other appropriate mechanism. A mobile platform may be associated with a vehicle, such as a paint module or carriage associated with a paint truck, an assessment module associated with a van, or a pressure-washing module associated with a truck, or may itself be a vehicle. A mobile platform may be operated by local control, such as a human driver or operator walking adjacent to or riding on or in the mobile platform or associated vehicle, or may be operated by remote human control, or may operate autonomously. Common mobile platforms include walk-behind vehicles, ride-on vehicles, and ride-in vehicles such as vans and trucks. While use of airborne vehicles, such as drones, would be constrained at least by the need to maintain airspace safety, their use is included within the present scope.

“Navigational change” refers to a change in one or more of direction or speed of the vehicle; a change in speed may be caused by accelerating, changing acceleration, ceasing acceleration, changing gears, or braking.

“Public safety vehicle” means a vehicle used to respond to a report of an accident, injury, hazard, or crime, including but not limited to ambulances, law enforcement vehicles, fire trucks, helicopters used for medical evacuation, tow/repair trucks, dump trucks, snow plows, and maintenance vehicles.

“Trajectory” refers to the path followed by a connected/autonomous vehicle during movement. A trajectory may include a drive vector.

“VMX” refers to digital data that represents information about a pavement segment, traffic conditions, weather conditions, infrastructure adjacent to or on the route of travel of a given vehicle, and any other information that may be relevant to vehicle navigation. Such data may include, but is not limited to, one or more of: information about a pavement segment including but not limited to the presence or absence of markings on a pavement segment, the condition of markings on a pavement segment, the retro-reflectivity of markings on a pavement segment, the color of markings on a pavement segment, the type of markings on a pavement segment (including but not limited to turn arrows, straight arrows, speed limits, cross walks, and stop indicators), data encoded in markings on a pavement segment, the presence of an edge of a pavement segment, the curvature of an edge of a pavement segment, the presence or absence of contaminants on a pavement segment (such as rubber marks from vehicle wheels, or of precipitation such as snow, slush, or ice), the presence or absence of debris on a pavement segment, and the presence or absence of structural flaws in the pavement segment such as cracks or potholes; information about traffic, including but not limited to the presence, type, absolute location, relative location, and/or speed of vehicles in the vicinity of a subject vehicle; information about ambient weather conditions, including but not limited to light levels, nature and intensity of precipitation, and presence and intensity of mist or fog; information about signs, lights, beacons, and other information provided visually, wirelessly, or otherwise to inform drivers and/or CAVs about traffic or weather conditions; and information about infrastructure adjacent or on the line of travel of a vehicle, including but not limited to the existence of, nature of, and distance to exits, merge lanes, lane changes, work zones, toll sites, accident sites, overpasses, tunnels, rest stops, and runaway truck ramps.

VMX data regarding the type of markings on a pavement segment may include whether a marking is a line and, if so, its color and/or pattern and/or relation to another line or lines. Such data may be used to determine the presence of pavement segment features and related information such as an edge line, a center line, a passing line, a no-passing line or lines, a merge indicator, or a bar code. This information may also be associated with absolute and/or relative location information and may, for example, provide a CAV with information regarding where a lane exists and how to remain safely within it, as well as additional information such as whether the markings are skips, denoting a second, adjacent lane and other navigational information, including information useful to a human operator. It will be appreciated that certain possible types of VMX data, such as the color of a marking, may be obtained through use of an imager, such as a charge-coupled device (CCD) or complementary metal oxide semiconductor (CMOS) imager. Imagers may be useful to, for example, capture and (as applicable) decode barcodes, machine-readable characters, symbols, and letters placed on pavement segments or on signage adjacent pavement segments; and/or to recognize features such as signs, types or shapes of signs, channeling devices, bridges, utility poles, crosswalks, and similar features, such as through the use of machine vision. However, the present application does not require the use of an imager to obtain VMX data that can be used to calculate drive vectors or trajectories for CAVs.

“Work zone” and “construction zone” both refer to an area in which a pavement segment is being prepared for work, is being worked on, or has been worked on but has not been fully prepared, restored, or returned for normal vehicle traffic, as well as a pavement segment where normal traffic flow is affected by utility work, such as by the presence of a utility truck at least partially obstructing a traffic lane. A work zone may involve construction as well as maintenance. Common but non-limiting examples of work zone activities or characteristics include paving, marking, lane shifts, lane closures, detours, and repairs. Work zones may involve the presence of one or more of challenging devices, temporary markings, barriers, visual alerts, signs, workers, and construction equipment.

### 2. Overview

The present application includes embodiments for the creation and utilization of vehicle target navigation boundaries and trajectories. In one aspect, the application includes a method which involves receiving, at a computing device, from a plurality of information sources, information related to the precise location of a pavement segment. The method may also comprise determining, using the computing device, an ideal path for navigating a given pavement segment, based on the information provided by the plurality of sources. This method may also comprise receiving, at a computing device, a plurality of information from pavement segment marking or modification equipment, and using the plurality of information to create or modify a preferred navigation path through a given pavement segment. Still further, the method may also comprise receiving, at a computing device, a plurality of information related to the status and location of a public safety vehicle, thereby modifying the ideal navigation trajectory for the nearby pavement segment.

In another aspect, the present application describes a non-transitory computer readable medium having stored thereon instructions executable by a computing device of a vehicle to provide the vehicle with navigation instructions. The navigation functions may include navigating through a specific pavement segment, such as through a construction zone; navigating to enable passage (including landing) of a public safety vehicle; or navigating around a stationary public safety vehicle. Further, the functions may comprise navigation of an autonomous vehicle, or visual assistance for a non-autonomous vehicle, along a pavement segment during low-visibility conditions, such as inclement weather.

In still another aspect, the present application describes a storage device or computer-readable medium provided on a remote server that may communicate with both the computing device described in the method and the non-transitory computer readable medium utilized by the computing device of a vehicle, whether autonomous or human-driven. As explained in further detail, this communication may be triggered by the detection and analysis of an off-vehicle image code and/or the detection of a radio signal that is a reference for retrieval of information from the server. This signal device may be located in the vicinity of a pavement segment used by the vehicle, such as on or next to the pavement segment, and/or immediately adjacent to the pavement segment, for example adjacent a roadway and within the usual distance from the roadway used to place signage for vehicles and drivers using the roadway.

In a yet further another aspect, the present application describes devices and processes for creating, assessing, and modifying pavement segment markings, including the capture of VMX data during such processes and use of that VMX data to create and/or update maps for use by CAVs.

While the present application is particularly suited for use in situations involving pavement segments in a non-standard environment, such as a work zone or in cases of low visibility due to inclement weather, it also extends to, for example, normal vehicle operation as well. In addition, and as described further herein, pavement segments may also involve short-term ad hoc situations, such as a stationary disabled vehicle or public safety vehicle, including one parked on or to the side of a pavement segment.

### 3. Environment of Use

A common environment of use for the present application is pavement segments utilized by vehicles. Such vehicles may commonly be cars, trucks, and vans; however, application of the present invention and concepts is not limited to only such vehicles, and may involve less sophisticated vehicles such as electric bicycles, motorized scooters, tuk tuks, and the like.

### 4. Connected and Autonomous Vehicles (CAVs)

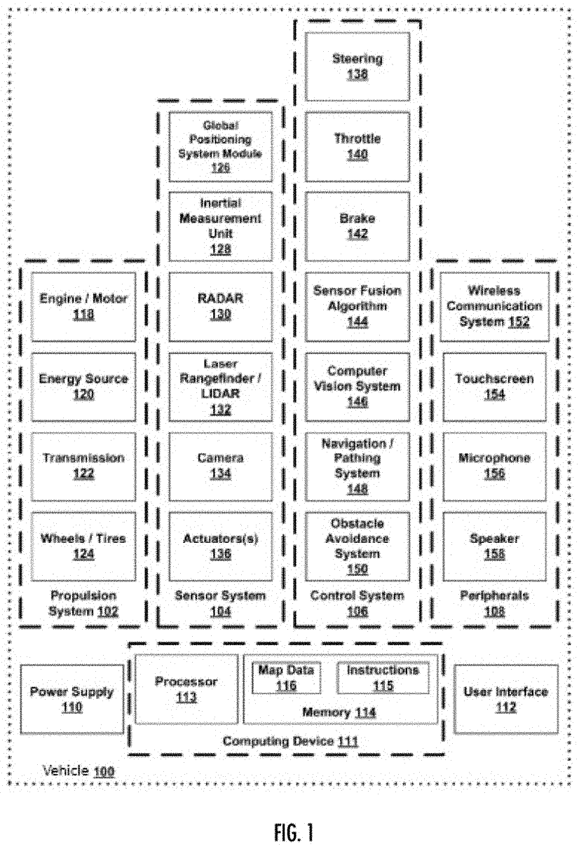

FIG. 1 is a simplified block diagram of an example CAV 100, in accordance with an example embodiment. Components coupled to or included in the CAV 100 may include a propulsion system 102, a sensor system 104, a control system 106, peripherals 108, a power supply 110, a computing device 111, and a user interface 112. The computing device 111 may include a processor 113, and a memory 114. The memory 114 may include instructions 115 executable by the processor 113, and may also store map data 116. Components of the CAV 100 may be configured to work in an interconnected fashion with each other and/or with other components coupled to respective systems. For example, the power supply 110 may provide power to all the components of the CAV 100. The computing device 111 may be configured to receive information from and control the propulsion system 102, the sensor system 104, the control system 106, and the peripherals 108. The computing device 111 may be configured to generate a display of images on and receive inputs from the user interface 112.

Navigation and pathing system 148 may be any system configured to determine a driving path for vehicle 100. The navigation and pathing system 148 may additionally be configured to update the driving path dynamically while vehicle 100 is in operation. In some examples, the navigation and pathing system 148 may be configured to incorporate data from the sensor fusion algorithm 144, the GPS module 126, and one or more predetermined maps so as to determine the driving path for vehicle 100.

In other examples, the CAV 100 may include more, fewer, or different systems, and each system may include more, fewer, or different components. Additionally, the systems and components shown may be combined or divided in any number of ways.

The propulsion system 102 may be configured to provide powered motion for the CAV 100. As shown, the propulsion system 102 includes an engine/motor 118, an energy source 120, a transmission 122, and wheels/tires 124.

The engine/motor 118 may be or include any combination of an internal combustion engine, an electric motor, a steam engine, and a Stirling engine. Other motors and engines are possible as well. In some examples, the propulsion system 102 could include multiple types of engines and/or motors. For instance, a gas-electric hybrid car could include a gasoline engine and an electric motor. Other examples are possible.

The energy source 120 may be a source of energy that powers the engine/motor 118 in full or in part. That is, the engine/motor 118 may be configured to convert the energy source 120 into mechanical energy. Examples of energy sources 120 include gasoline, diesel, other petroleum-based fuels, propane, other compressed gas-based fuels, ethanol, solar panels, batteries, and other sources of electrical power. The energy source(s) 120 could additionally or alternatively include any combination of fuel tanks, batteries, capacitors, and/or flywheels. In some examples, the energy source 120 may provide energy for other systems of the CAV 100 as well.

The transmission 122 may be configured to transmit mechanical power from the engine/motor 118 to the wheels/tires 124. To this end, the transmission 122 may include a gearbox, clutch, differential, drive shafts, and/or other elements. In examples where the transmission 122 includes drive shafts, the drive shafts could include one or more axles that are configured to be coupled to the wheels/tires 124.

The wheels/tires 124 of CAV 100 could be configured in various formats, including a unicycle, bicycle/motorcycle, tricycle, or car/truck four-wheel format. Other wheel/tire formats are possible as well, such as those including six or more wheels. The wheels/tires 124 of CAV 100 may be configured to rotate differentially with respect to other wheels/tires 124. In some examples, the wheels/tires 124 may include at least one wheel that is fixedly attached to the transmission 122 and at least one tire coupled to a rim of the wheel that could make contact with the driving surface. The wheels/tires 124 may include any combination of metal and rubber, or combination of other materials.

The propulsion system 102 may additionally or alternatively include components other than those shown.

The sensor system 104 may include a number of sensors configured to sense information about an environment in which the CAV 100 is located. As shown, the sensors of the sensor system include a Global Navigation Satellite System (GNSS) module 126, an inertial measurement unit (IMU) 128, a radio detection and ranging (RADAR) unit 130, a laser rangefinder and/or light detection and ranging (LIDAR) unit 132, a camera 134, and actuators 136 configured to modify a position and/or orientation of the sensors. The sensor system 104 may include additional sensors as well, including, for example, sensors that monitor internal systems of the CAV 100 (e.g., an O2 monitor, a fuel gauge, an engine oil temperature, etc.). Other sensors are possible as well.

The GNSS module 126 may be any sensor configured to estimate a geographic location of the CAV 100, including a GPS sensor. To this end, the GNSS module 126 may include a transceiver configured to estimate a position of the CAV 100 with respect to the Earth, based on satellite-based positioning data. In an example, the computing device 111 may be configured to use the GNSS module 126 in combination with the map data 116 to estimate a location of a lane boundary on road on which the CAV 100 may be travelling on. The GNSS module 126 may take other forms as well.

The IMU 128 may be any combination of sensors configured to sense position and orientation changes of the CAV 100 based on inertial acceleration. In some examples, the combination of sensors may include, for example, accelerometers and gyroscopes. Other combinations of sensors are possible as well.

The RADAR unit 130 may be considered as an object detection system that may be configured to use radio waves to determine characteristics of the object such as range, altitude, direction, or speed of the object. The RADAR unit 130 may be configured to transmit pulses of radio waves or microwaves that may bounce off any object in a path of the waves. The object may return a part of energy of the waves to a receiver (e.g., dish or antenna), which may be part of the RADAR unit 130 as well. The RADAR unit 130 also may be configured to perform digital signal processing of received signals (bouncing off the object) and may be configured to identify the object.

Other systems similar to RADAR have been used in other parts of the electromagnetic spectrum. One example is LIDAR (light detection and ranging), which may be configured to use visible light from lasers rather than radio waves.

The LIDAR unit 132 may include a sensor configured to sense or detect objects in an environment in which the CAV 100 is located using light. Generally, LIDAR is an optical remote sensing technology that can measure distance to, or other properties of, a target by illuminating the target with light. The light can be any type of electromagnetic waves such as laser. As an example, the LIDAR unit 132 may include a laser source and/or laser scanner configured to emit pulses of laser and a detector configured to receive reflections of the laser. For example, the LIDAR unit 132 may include a laser range finder reflected by a rotating mirror, and the laser is scanned around a scene being digitized, in one or two dimensions, gathering distance measurements at specified angle intervals. In examples, the LIDAR unit 132 may include components such as light (e.g., laser) source, scanner and optics, photo-detector and receiver electronics, and position and navigation system.

In an example, The LIDAR unit 132 may be configured to use ultraviolet (UV), visible, or infrared light to image objects and can be used with a wide range of targets, including non-metallic objects. In one example, a narrow laser beam can be used to map physical features of an object with high resolution.

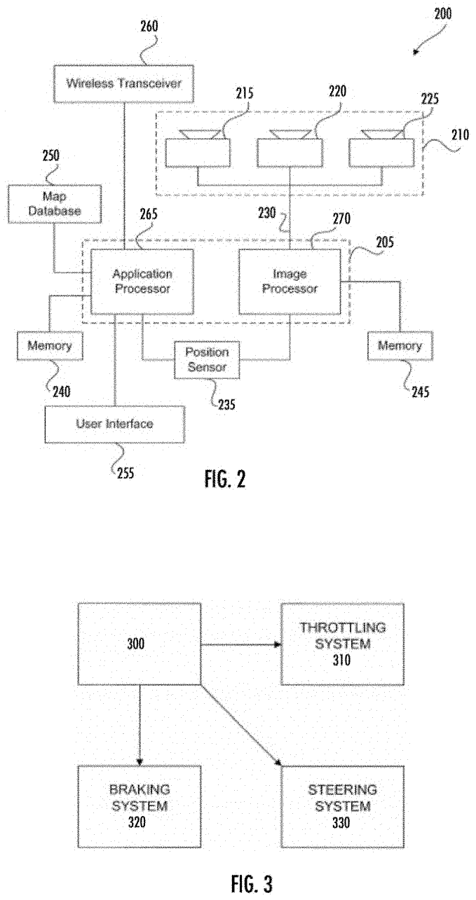

FIG. 2 is a block diagram representation of a system 200 which may include various components depending on the requirements of a particular implementation. In some embodiments, system 200 may include a processing unit 205, an image acquisition unit 210, a position sensor 235, one or more memory units 240, 245, a map database 250, a user interface 255, and a wireless transceiver 260. Processing unit 205 may include one or more processing devices. In some embodiments, processing unit 205 may include an applications processor, an image processor, or any other suitable processing device. Similarly, image acquisition unit 210 may include any number of image acquisition devices and components depending on the requirements of a particular application. In some embodiments, image acquisition unit 210 may include one or more image capture devices (e.g., cameras), such as image capture device 215, image capture device 220, and image capture device 225. System 200 may also include a data interface 230 communicatively connecting processing device 205 to image acquisition device 210. For example, data interface 230 may include any wired and/or wireless link or links for transmitting image data acquired by image accusation device 210 to processing unit 205.

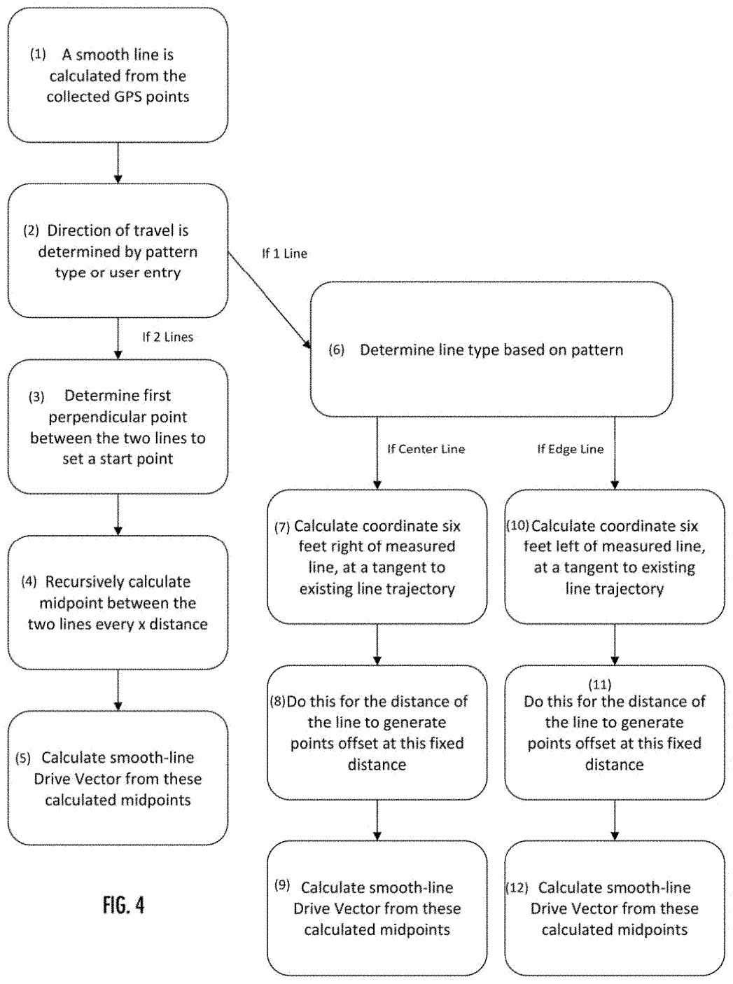

FIG. 3 is a diagrammatic representation of exemplary CAV control system 300, which may include throttling system 310, braking system 320, and steering system 330. System 300 may provide inputs (e.g., control signals) to one or more of throttling system 310, braking system 320, and steering system 330 over one or more data links (e.g., any wired and/or wireless link or links for transmitting data). For example, based on analysis of images acquired by image capture devices 215, 220, and/or 225 FIG. 2, system 300 may provide control signals to one or more of throttling system 310, braking system 320, and steering system 330 to navigate a CAV (e.g., by causing an acceleration, a turn, a lane shift, etc.). Further, system 300 may receive inputs from one or more of throttling system 310, braking system 320, and steering system 330 indicating operating conditions of the CAV (e.g., speed, whether the CAV is braking and/or turning, etc.).

With reference to FIGS. 2, 3, 7, and 8, a CAV may contain navigational response module 850 which stores software executable by processing unit 205 to determine a desired navigational response based on data derived from execution of monocular image analysis module 820 and/or stereo image analysis module 830. Such data may include position and speed information associated with nearby vehicles, pedestrians, and road objects, target position information for the CAV, and the like. Additionally, the navigational response may be based (partially or fully) on map data, a predetermined position of the CAV, and/or a relative velocity or a relative acceleration between the CAV and one or more objects detected from execution of monocular image analysis module 820 and/or stereo image analysis module 830.

Navigational response module 850 may also determine a desired navigational response based on sensory input (e.g., information from radar) and inputs from other systems of the CAV, such as throttling system 310, braking system 320, and steering system 339. Based on the desired navigational response, processing unit 205 may transmit electronic signals to throttling system 310, braking system 320, and steering system 330 to trigger a desired navigational response by, for example, turning the steering wheel of the CAV to achieve a rotation of a predetermined angle. In some embodiments, processing unit 205 may use the output of navigational response module 850 (e.g., the desired navigational response) as an input to execution of velocity and acceleration module 840 for calculating a change in speed of the CAV.

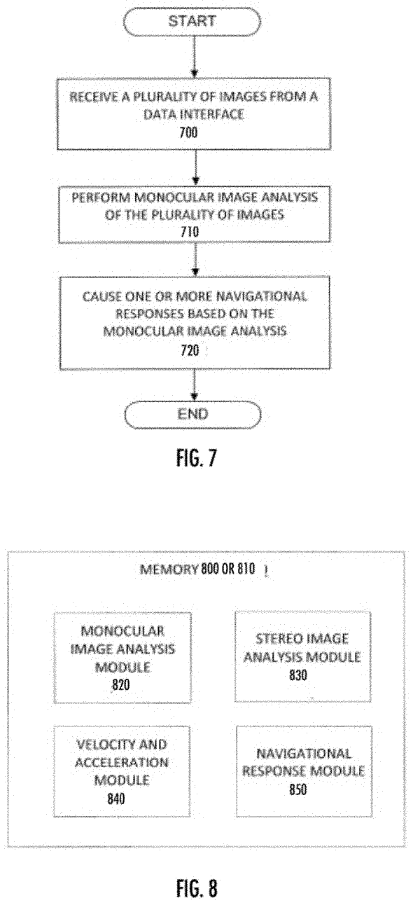

FIG. 7 is a flowchart showing one process for causing one or more navigational responses based on monocular image analysis. At step 700, processing unit 205 may receive a plurality of images via data interface 230 between processing unit 205 and image acquisition unit 210. For instance, a camera included in image acquisition unit 210 (such as image capture device 215 having a given field of view) may capture a plurality of images of an area forward, rearward, or to the side or sides of the CAV and transmit them over a data connection (e.g., digital, wired, USB, wireless, Bluetooth, etc.) to processing unit 205.

Processing unit 205 may execute monocular image analysis module 820 to analyze the plurality of images at step 710. By performing such analysis, processing unit 205 may detect a set of features within the set of images, such as lane markings, vehicles, pedestrians, road signs, highway exit ramps, traffic lights, and the like.

FIG. 8 is an exemplary functional block diagram of memory 800 and/or 810, which may be stored/programmed with instructions for performing one or more operations consistent with the disclosed embodiments. Although the following refers to memory 800, one of skill in the art will recognize that instructions may be stored in memory 800 and/or 810. As shown in FIG. 4, memory 800 may store a monocular image analysis module 820, a stereo image analysis module 830, a velocity and acceleration module 840, and a navigational response module 850. The disclosed embodiments are not limited to any particular configuration of memory 800. Further, application processor 265 and/or image processor 270 may execute the instructions stored in any of modules 820-850 included in memory 800. One of skill in the art will understand that references herein to processing unit 205 may refer to application processor 265 and image processor 270 individually or collectively. Accordingly, steps of any of the corresponding processes may be performed by one or more processing devices.

A CAV navigation system may include a closed loop subsystem, in which estimation of the CAV's six degrees of freedom location (e.g., three-dimensional position data plus three-dimensional orientation data) may be used for navigating the CAV. In turn, data measured from the steering and actual navigation may be used to estimate the six degrees of freedom location.

A CAV navigation system may include other features. For example, the system may use local coordinates, rather than global coordinates. For autonomous driving, some systems may present data in world coordinates; for example, longitude and latitude coordinates on the earth surface may be used. In order to use the map for steering, the host vehicle must know its position and orientation relative to the map. This may be accomplished by using a GPS device on board the CAV, in order to position the vehicle on the map and to find the rotation transformation between the body reference frame and the world reference frame (such as North, East, and Down). Once the body reference frame is aligned with the map reference frame, the desired route may be expressed in the body reference frame and steering commands may be computed or generated.

### 5. Control/Operation of CAVs

Generally, a control strategy for a CAV may include one or more sets of rules associated with traffic interaction in various driving contexts, such as approaching a construction zone. The control strategy may comprise rules that determine a speed of the vehicle and a lane that the vehicle may travel on while taking into account safety and traffic rules and concerns such as changes in road geometry due to existence of a construction zone, vehicles stopped at an intersection, windows-of-opportunity in a yield situation, lane tracking, speed control, distance from other vehicles on the road, passing other vehicles, queuing in stop-and-go traffic, and avoiding areas that may result in unsafe behavior such as oncoming-traffic lanes. For instance, in approaching a construction zone a computing device in a CAV may be configured to modify or select, based on the determined likelihood of the existence of the construction zone, a control strategy comprising rules for actions that control the vehicle speed to safely maintain a distance with respect to other vehicles and objects, and select a lane that is considered optimal to safety given road changes due to the existence of the construction zone.

### 6. Sparse Maps

An autonomous vehicle may use a sparse map for navigation, in which one or more three-dimensional contours may represent predetermined trajectories that autonomous vehicles may traverse as they move along associated pavement segments. A sparse map may also include data representing one or more pavement features. Such pavement features may include recognized landmarks, pavement signature profiles, and any other pavement-related features useful in navigating a vehicle.

The sparse maps may enable autonomous navigation of a vehicle based on relatively small amounts of data included in the sparse map. For example, rather than including detailed representations of a pavement segment, such as pavement edges, pavement curvature, images associated with pavement segments, or data detailing other physical features associated with a pavement segment, the disclosed embodiments of the sparse map may require relatively little storage space (and relatively little bandwidth when portions of the sparse map are transferred to a vehicle), but may still adequately provide for autonomous vehicle navigation. The small data footprint of such sparse maps may be achieved in some embodiments by storing representations of pavement -related elements that require small amounts of data, but still enable autonomous navigation. For example, rather than storing detailed representations of various aspects of a pavement segment, the disclosed sparse maps may store polynomial representations of one or more boundaries of or adjacent to a pavement segment, and/or of trajectories that a vehicle may follow along the pavement segment.

Thus, rather than storing (or having to transfer) details regarding the physical nature of the pavement segment to enable navigation along the pavement segment, using the disclosed sparse maps, a vehicle may be navigated along a particular pavement segment without, in some cases, having to interpret physical aspects of the pavement segment, but rather, by aligning its path of travel with a trajectory (e.g., a polynomial spline) along the particular pavement segment. In this way, the vehicle may be navigated based mainly upon the stored trajectory (e.g., a polynomial spline) that may require much less storage space than an approach involving storage of pavement images, pavement parameters, pavement layout, and the like.

With reference to FIG. 9, sparse map 800 may include representations of a plurality of target trajectories 920 for guiding an autonomous vehicle along a pavement segment. Such target trajectories may be stored as three-dimensional splines. The target trajectories stored in sparse map 800 may be determined based on two or more reconstructed trajectories of prior traversals of vehicles along a particular pavement segment. A pavement segment may be associated with a single target trajectory or multiple target trajectories. For example, on a two-lane road, a first target trajectory may be stored to represent an intended path of travel along the road in a first direction, and a second target trajectory may be stored to represent an intended path of travel along the road in another direction (e.g., opposite to the first direction). Additional target trajectories may be stored with respect to a particular pavement segment. For example, on a multi-lane road one or more target trajectories may be stored representing intended paths of travel for vehicles in one or more lanes associated with the multi-lane road. In some embodiments, each lane of a multi-lane road may be associated with its own target trajectory. In other embodiments, there may be fewer target trajectories stored than lanes present on a multi-lane road. In such cases, a vehicle navigating the multi-lane road may use any of the stored target trajectories to guides its navigation by taking into account an amount of lane offset from a lane for which a target trajectory is stored (e.g., if a vehicle is traveling in the left-most lane of a three lane highway, and a target trajectory is stored only for the middle lane of the highway, the vehicle may navigate using the target trajectory of the middle lane by accounting for the amount of lane offset between the middle lane and the left-most lane when generating navigational instructions).

Different trajectories may be generated and included in sparse map 800 based on different environmental conditions, such as day and night, snow, rain, and fog. Autonomous vehicles driving under different environmental conditions may be provided with different sparse maps generated based on such different environmental conditions. In some embodiments, cameras provided on autonomous vehicles may detect the environmental conditions, and may provide such information back to a server that generates and provides sparse maps. For example, the server may generate or update an already generated sparse map 800 to include trajectories that may be more suitable or safer for autonomous driving under the detected environmental conditions. The update of sparse map 800 based on environmental conditions may be performed dynamically as the autonomous vehicles are traveling along roads.

The CAV navigation system may use a sparse road model. For example, the system may provide navigation based on recognized landmarks, align a vehicle's tail for navigation, allow a vehicle to navigate road junctions, allow a vehicle to navigate using local overlapping maps, allow a vehicle to navigate using a sparse map, navigate a vehicle based on an expected landmark location, autonomously navigate a vehicle based on VMX data, navigate a vehicle forward based on a rearward facing camera, navigate a vehicle based on a free space determination, and navigate a vehicle in snow.

Further with regard to the target trajectories a vehicle may use to navigate a particular pavement segment, FIG. 12 shows polynomial representations of trajectories captured during a process of building or maintaining sparse map 800. A polynomial representation of a target trajectory included in sparse map 800 may be determined based on two or more reconstructed trajectories of prior traversals of vehicles along the same pavement segment. In some embodiments, the polynomial representation of the target trajectory included in sparse map 800 may be an aggregation of two or more reconstructed trajectories of prior traversals of vehicles along the same pavement segment. In some embodiments, the polynomial representation of the target trajectory included in sparse map 800 may be an average of the two or more reconstructed trajectories of prior traversals of vehicles along the same pavement segment. Other mathematical operations may also be used to construct a target trajectory along a road path based on reconstructed trajectories collected from vehicles traversing along a pavement segment.

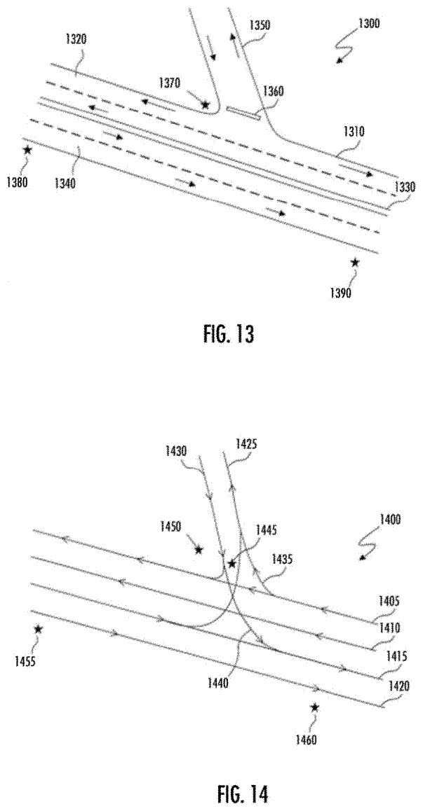

FIGS. 13 and 14 further illustrate the concept of target trajectories associated with road segments present within a geographic region 1300. As shown in FIG. 13, a first road segment 1310 within geographic region 1300 may include a multilane road, which includes two lanes 1320 designated for vehicle travel in a first direction and two additional lanes 1340 designated for vehicle travel in a second direction opposite to the first direction. Lanes 1320 and lanes 1340 may be separated by a double yellow line 1330. Geographic region 1300 may also include a branching road segment 1350 that intersects with road segment 1310. Road segment 1350 may include a two-lane road, each lane being designated for a different direction of travel. Geographic region 1300 may also include other road features, such as a stop line 1360, a stop sign 1370, a speed limit sign 1380, and a hazard sign 1390. As shown in FIG. 14, sparse map 800 may include a local map 1400 including a road model for assisting with autonomous navigation of vehicles within geographic region 1300. For example, local map 1400 may include target trajectories for one or more lanes associated with road segments 1310 and/or 1350 within geographic region 1300. For example, local map 1400 may include target trajectories 1405 and/or 1410 that an autonomous vehicle may access or rely upon when traversing lanes 1320. Similarly, local map 1400 may include target trajectories 1415 and/or 1420 that an autonomous vehicle may access or rely upon when traversing lanes 1340. Further, local map 1400 may include target trajectories 1425 and/or 1430 that an autonomous vehicle may access or rely upon when traversing road segment 1350. Target trajectory 1435 represents a preferred path an autonomous vehicle should follow when transitioning from lanes 1310 (and specifically, relative to target trajectory 1405 associated with a right-most lane of lanes 1310) to road segment 1350 (and specifically, relative to a target trajectory 1425 associated with a first side of road segment 1350). Similarly, target trajectory 1440 represents a preferred path an autonomous vehicle should follow when transitioning from road segment 1320 (and specifically, relative to target trajectory 1430) to a portion of road segment 1340 (and specifically, as shown, relative to a target trajectory 1415 associated with a left lane of lanes 1340). Sparse map 800 may also include representations of other road-related features associated with geographic region 1300. For example, sparse map 800 may also include representations of one or more landmarks identified in geographic region 1300. Such landmarks may include a first landmark 1445 associated with stop line 1360, a second landmark 1450 associated with stop sign 1370, a third landmark associated with speed limit sign 1455, and a fourth landmark 1460 associated with hazard sign 1390. Such landmarks may be used, for example, to assist an autonomous vehicle in determining its current location relative to any of the shown target trajectories, such that the vehicle may adjust its heading to match a direction of the target trajectory at the determined location

Additionally, a CAV navigation system may provide speed calibration, determine a lane assignment of a vehicle based on a recognized landmark location, and use information from plural landmarks as navigation aids.

### 7. Calculation of Smooth Line Markings

Marking location data captured by the present system may be used to create a polynomial representation of a preferred trajectory for vehicles navigating the analyzed pavement segment. The drive vector is determined by finding the middle point between each edge line. The left lane drive vector is the smooth lined average of the left edge line and the right edge line of the left most lane. These drive vectors are ideal routes for a vehicle to drive, simplifying driving calculations since markings provide the edges, which must then be used to determine middles; whereas, these provide a suggested middle for the CAV to use and improve upon via real-world sensors, for example, the sensors aboard the one or more vehicles (e.g., cameras, radar, LiDAR, speedometers, GPS, accelerometers, etc.). A drive vector is a polynomial representation of a preferred vehicle trajectory. In some embodiments, this can communicate a trajectory around a curve, where the vehicle gets the radius information and can use this instead of specific data points, reducing the need for high resolution coordinate data.

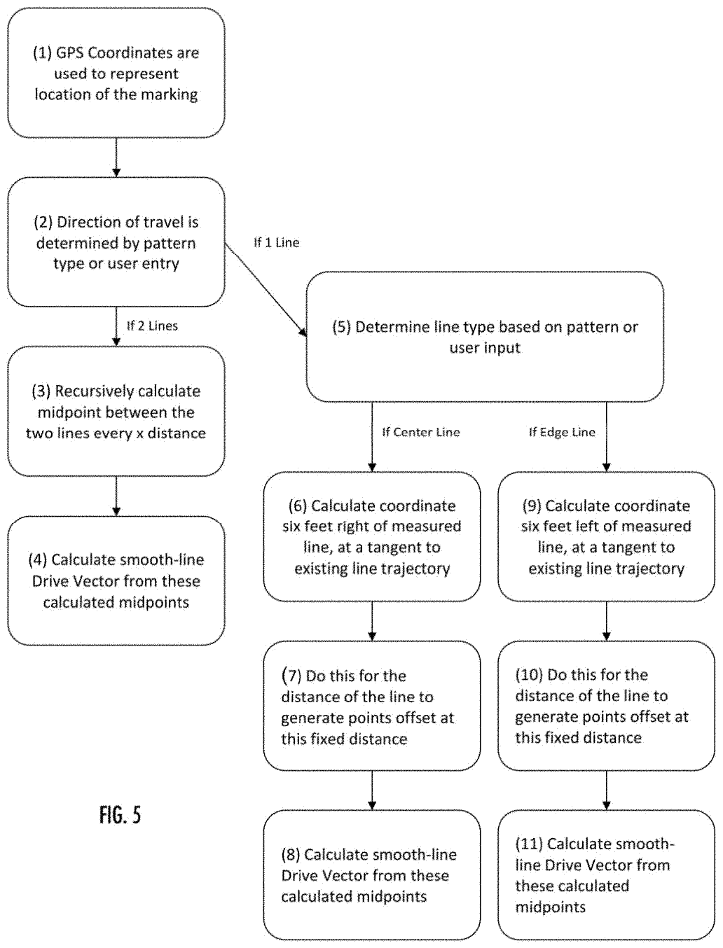

As shown in FIGS. 4 and 5, one embodiment of the proposed invention is the calculation of these polynomial representations of best route of travel (“drive vectors”) from GPS points collected from the position sensor of the present system. (1) In this embodiment, the marking position or virtual pavement marking is determined from the GPS data collected by the system. (2) Whether by user input or by information provided by the additional optional sensors in the system (e.g. a paint control system), the direction of vehicle travel is determined in relation to the virtual pavement marking. For example, a double yellow marking in the United States is known to have vehicles traveling with their driver side facing the marking. This context is useful so that the drive vector can contain this travel direction information. This direction data is particularly important in the special case where travel direction might change, such as in a work zone.

When the locations of two pavement marking lines are known, (4) the midpoint of these two lines can be calculated by taking the average of each coordinate point perpendicular to the other. This is done recursively to determine the best representation of the midpoint of the two markings. From here, (5) a smooth-line polynomial is determined from these midpoint coordinates. Processing unit 205 may calculate the geometric midpoint between the two polynomials and offset each point included in the resultant vehicle path by a predetermined offset (e.g., a smart lane offset), if any (an offset of zero may correspond to travel in the middle of a lane). The offset may be in a direction perpendicular to a segment between any two points in the vehicle path. This smart offset may be in reference to a lane, or another vector altogether, such as the middle of the road itself. In another embodiment, processing unit 205 may use one polynomial and an estimated lane width to offset each point of the vehicle path by half the estimated lane width plus a predetermined offset (e.g., a smart lane offset).

In some embodiments, only one line may be available (6). The pattern of this marking might be determined using the same paint control system logic described above or by user entry. If the marking is a center line, the drive vector may be calculated to the right of the measured line, whereas if the marking is an edge line, the drive vector may be calculated to the left of the measured line. In an example where the drive vector is desired to be located six feet from the center line, (7) a coordinate set is calculated six feet perpendicular to each measured point in the dataset. This is done for all coordinate points in the dataset (8). A smooth-line polynomial representative of vehicle trajectory is then calculated from the newly generated coordinate set (9) of midpoints. This same embodiment can be performed for the edge line, where the offset is calculated to the left of the collected coordinate data (10-12).

While this is represented as polynomials extending in 2D space (e.g., on the surface of the paper), it is to be understood that these polynomials may represent curves extending in three dimensions (e.g., including a height component) to represent elevation changes in a pavement segment in addition to X-Y curvature.

In the autonomous vehicle road navigation model, the geometry of a road feature or target trajectory may be encoded by a curve in a three-dimensional space. In one embodiment, the curve may be a three-dimensional spline including one or more connecting three dimensional polynomials. As one of skill in the art would understand, a spline may be a numerical function that is piecewise defined by a series of polynomials for fitting data. A spline for fitting the three-dimensional geometry data of the road may include a linear spline (first order), a quadratic spline (second order), a cubic spline (third order), or any other splines (other orders), or a combination thereof. The spline may include one or more three dimensional polynomials of different orders connecting (e.g., fitting) data points of the three-dimensional geometry data of the road. In some embodiments, the autonomous vehicle road navigation model may include a three-dimensional spline corresponding to a target trajectory along a common pavement segment (e.g., pavement segment 1400 of FIG. 14) or a lane of the pavement segment.

### 8. Capture, Communication, and Use of Pavement Segment Marking VMX Data

VMX markings can be captured during normal pavement segment marking operations, with minimal change to the broader striping activity. When a typical road is repainted, the striping equipment is equipped with high-precision GNSS equipment as described herein so as to capture the precise coordinate location of the markings as they are painted. This coordinate data is then synchronized with a central VMX database, so as to maintain a constantly up-to-date location for all pavement markings.

The pGPS data may be associated with the lane marking pattern type, allowing for additional context for navigation purposes. Unlike in the special example of the work zone, where lane changes are typically discouraged, this information is useful for improved navigation in the more generalized case.

FIG. 18 shows one process for capturing pGPS data and calculating a drive vector when a work zone is set up. pGPS data is captured and stored as temporary pavement segment markings are applied in the work zone. The paint and pGPS data is transmitted to a server, which may be but is not necessarily cloud-based, and provided to a processor for calculation of a drive vector from pGPS data representing edge lines of the pavement segment.

Once collected, VMX data representing actual or virtual markings can be used for various purposes, not only by a CAV, but also by standard modern vehicles with lane-keeping and similar awareness technology. In the case of CAVs this coordinate data can be continuously downloaded, to simplify the on-vehicle navigation calculations. This redundant dataset can be used in conjunction with the sensors, such as radar, imager, and LiDAR, to determine the safest and most efficient route through which to navigate a typical roadway.

In the case of non-CAVs, the VMX dataset can be used to assist navigation by the human driver, particularly in environments where visibility is restricted, such as during inclement weather like a snowstorm. As shown in FIGS. 13 and 14 the left and right edge lines, as well as a predetermined drive vector, can be used for the safe navigation of the off-ramp of a highway. With the appropriate hardware on-board, the VMX data shown in this figure could be displayed on a semi-transparent “Heads Up Display” (HUD), or windshield. The VMX data would be represented as lines on the HUD indicating the actual location of the markings in the real world. This would provide the additional context of where the edge markings are in relation to the vehicle's current position, assisting in safe navigation of the off-ramp. This can be used in any situation where overlaid representation of marking location would be useful, not just the off-ramp example shown here.

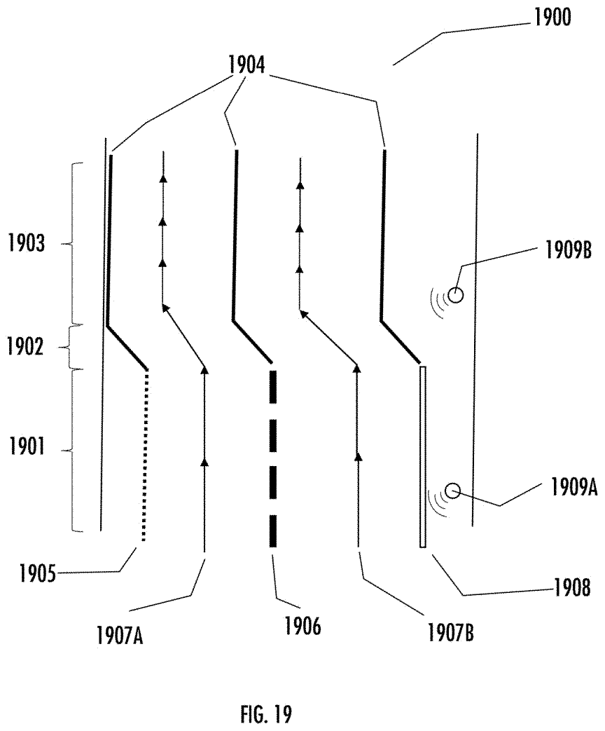

Various components may be utilized for the communication of drive vector data between a remote server and one or more CAVs. With reference to FIG. 19, In one such embodiment, a “hub beacon” may be utilized for communication with a vehicle as it or prior to it entering a given pavement segment. In FIG. 19, a representative work zone 1900 includes regular traffic lane zone 1901 having regular traffic lane center line 1905, shift traffic lane zone 1902, and work traffic lane zone 1903, and may be bounded by at least one traffic lane edge line 1908. Vehicles approaching work zone 1900 will need to navigate a lane shift as they move from regular traffic lane zone 1901 to shift traffic lane zone 1902, and another lane shift as they move from shift traffic lane zone 1902 to work traffic lane zone 1903. These transitions may also involve moving from a passing zone in regular traffic lane zone 1901, indicated by dashed line 1906, to a no-passing zone in shift traffic lane zone 1902 and work traffic lane zone 1903, indicated by solid lines 1904. Upon approaching work zone 1900, hub beacon 1909A may communicate directly with an approaching CAV, providing the CAV with the most recent drive vector data such as first trajectory 1907A and/or second trajectory 1907B for navigating from regular traffic lane zone 1901, through shift traffic lane zone 1902, and onto work traffic lane zone 1903. Hub beacon 1909A may include one or more devices configured to exchange transmissions over an air interface to one or more networks (e.g., cellular, the Internet, etc.) by use of a radio frequency, infrared frequency, magnetic field, or an electric field. The wireless transceiver may use any known standard to transmit and/or receive data, including by peer-to-peer (“P2P”) and vehicle-to-vehicle, or V2V, communication. (For purposes of the present application, any transmission of wireless data discussed herein may take place over any technology appropriate for the particular use and use environment, including but not limited to Wi-Fi, Bluetooth®, Bluetooth Smart, 802.15.4, ZigBee, P2P, V2V, and cellular, including 5G.) Hub beacon 1909A may be located near or in a roadway. This point-to-point communication can be used for sharing the most recent data between vehicles as well, should the data be updated while a vehicle is already navigating through the work zone. As the CAV moves along or exits work zone 1900, at least a second hub beacon 1909B may provide the CAV with VMX data for transitioning from the work zone back to a non-work zone, and/or receive data from the CAV regarding the real-time conditions it encountered moving through work zone 1900 to update VMX data for subsequent CAVs approaching work zone 1900.

Using, for example, optical or laser (lidar) based imaging techniques, the vehicle may read a pre-generated barcode that has been printed onto a pavement segment. This barcode can include information necessary for faster acquisition of the drive vector data, such as a URL for download, or a unique ID for identifying the specific pavement segment being navigated. Additional information can be encoded into these barcodes as well, especially for increased data quality assurance. For example, if the upcoming pavement segment involves a ten-foot lane shift to the left, a corresponding message can be encoded into the barcode for direct read by the vehicle as additional context even prior to the download of the drive vector data.

Both the barcode and hub beacon may be located or arranged on or next to the pavement segment being navigated by the vehicle. In some embodiments, these may be positioned before the beginning or entrance to a pavement segment. They may also be mounted on a mobile support, for example a vehicle or trailer, or a rigid support, such as a sign post or overpass. An advantage of these optional components is that changes can be made in real-time, and the vehicle can be triggered to retrieve the most recent dataset.

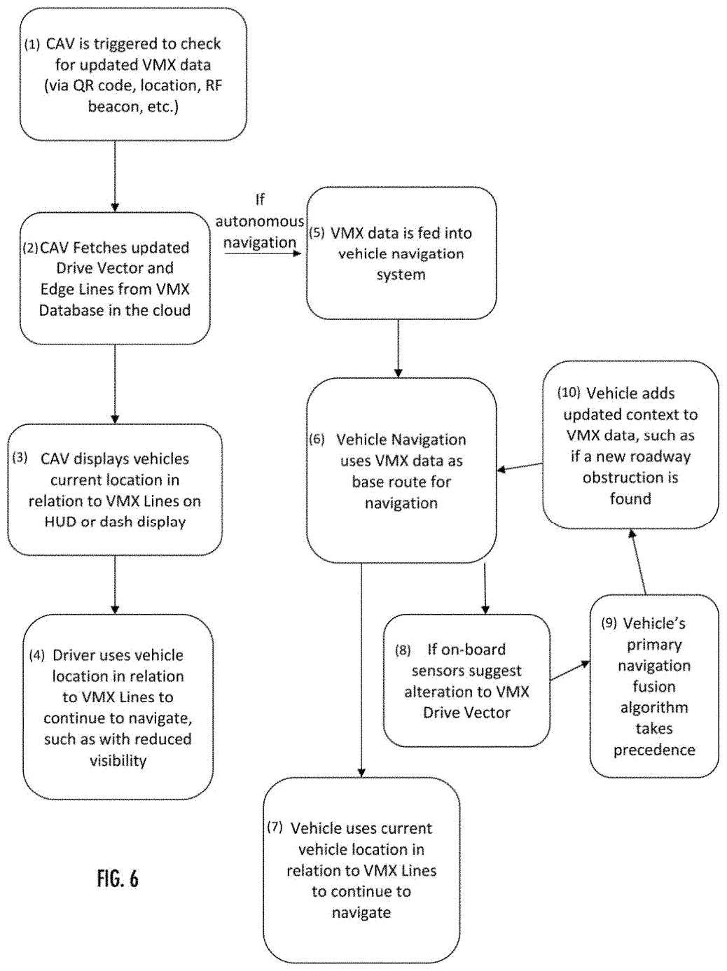

FIG. 6 represents one process whereby a CAV may navigate along a given pavement segment. A signal triggers the CAV to query for updated VMX data for the pavement segment. This signal may be provided by any appropriate device including but not limited to a barcode, such as one placed on the pavement segment or on adjacent signage and captured by an imager on the CAV; an RF beacon; a transmission from another CAV; and the location of the CAV as provided by GNSS or other location or position sensor data. If updated VMX data is available the CAV acquires it, such as by downloading from cloud-based storage, and/or directly from the transmission. If the CAV is operating in autonomous mode, the updated VMX data is provided to the CAZV navigation system and used by the system to navigate the pavement segment. If, during such navigation, the sensors on the CAV detect any conditions or features indicating deviation from the trajectory provided through the updated VMX data, the CAV's primary navigation fusion algorithm takes precedence, the CAV generates revised updated VMX data, and that revised updated VMX data is used for navigation, and may also be uploaded to cloud-based storage and/or transmitted to other CAVs in the vicinity of the pavement segment. If the CAV is under human control, the updated VMX information is made available to the human operator visually and/or audibly, such as through a dashboard or heads'-up display, and/or voice input.

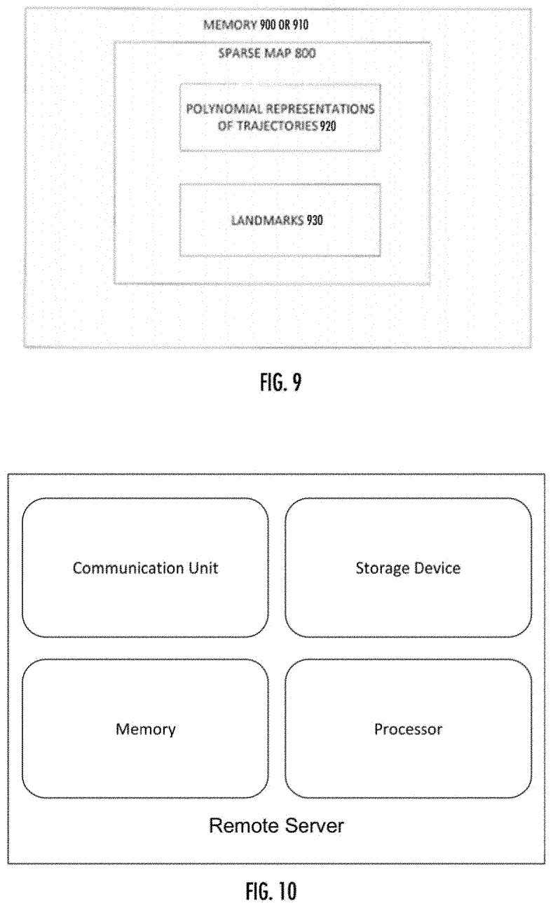

Drive vector data may be stored on a storage device or computer-readable medium on a remote server that communicates with both the present system and vehicles that utilize it. With reference to FIG. 10, in some embodiments the remote server might consist of a communication unit, a storage device, memory, and a processor. The server may store the navigation information on a storage device, or non-transitory computer-readable medium, including magnetic storage media such as hard drives or tapes; optical storage media such as compact discs or DVDs; solid state storage media such as solid state drives and so-called “flash” storage devices such as USB or “thumb” drives; or any other suitable storage media. The server may generate, such as through the processor, some of the drive vector calculations described herein based on the data collected by the system. The server may transmit the relevant data to one or more autonomous vehicles traveling on a pavement segment, or store the data for later use in navigating a pavement segment.

A processor (e.g., processing unit) provided on the vehicle may receive the drive vector data from the remote server and may execute the data for guiding the autonomous driving of the vehicle. In such embodiments, the drive vector data may be made accessible to a plurality of vehicles traversing various pavement segments. It should be noted that there may be multiple drive vectors for any given road. This may occur when there are multiple lanes on a given road, or when a given lane has multiple options available to it. One such example is the right-most lane on a highway from which a vehicle may either continue on the highway, or take an exit. Such a lane may have two drive vectors, one for staying on the highway and a second for navigating the exit.

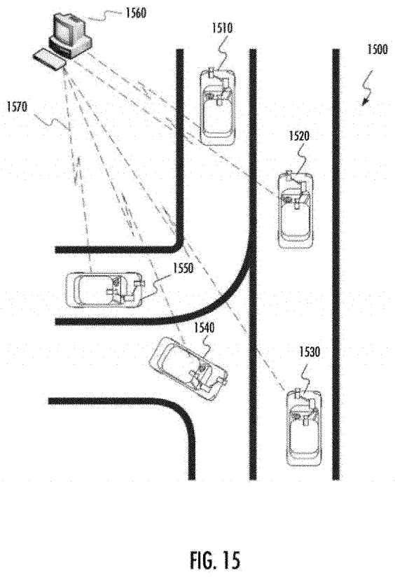

FIG. 15 is a schematic illustration of a system that uses crowd sourcing data for autonomous vehicle navigation. FIG. 15 shows a road segment 1500 that includes one or more lanes. A plurality of vehicles 1510, 1520, 1530, 1540, and 1550, may travel on road segment 1500 at the same time or at different times (although shown as appearing on road segment 1500 at the same time in FIG. 15). At least one of vehicles 1510-1550 may be an autonomous vehicle. For simplicity of the present example, all of the vehicles 1510-1550 are presumed to be autonomous vehicles. Each vehicle may be similar to vehicles disclosed in other embodiments (e.g., vehicle 100), and may include components or devices included in or associated with vehicles disclosed in other embodiments. Each vehicle may be equipped with an image capture device or camera (e.g., camera 134 or image capture device 215, 220, or 225). Each vehicle may communicate with a remote server 1560 via one or more networks (e.g., over a cellular network and/or the Internet, etc.) through wireless communication paths 1570, as indicated by the dashed lines. Each vehicle may transmit data to server 1560 and receive data from server 1560. For example, server 1560 may collect data from multiple vehicles travelling on the road segment 1500 at different times, and may process the collected data to generate an autonomous vehicle road navigation model, or an update to the model. Server 1560 may transmit the autonomous vehicle road navigation model or the update to the model to the vehicles that transmitted data to server 1560. Server 1560 may transmit the autonomous vehicle road navigation model or the update to the model to other vehicles that travel on road segment 1500 at later times.

As vehicles 1510-1550 travel on road segment 1500, navigation information collected (e.g., detected, sensed, or measured) by vehicles 1510-1550 may be transmitted to server 1560. h some embodiments, the navigation information may be associated with the common road segment 1500. The navigation information may include a trajectory associated with each of the vehicles 1510-1550 as each vehicle travels over road segment 1500. In some embodiments, the trajectory may be reconstructed based on data sensed by various sensors and devices provided on vehicle 1510. For example, the trajectory may be reconstructed based on at least one of accelerometer data, speed data, landmarks data, road geometry or profile data, vehicle positioning data, and ego motion data such as three-dimensional translation and three-dimensional rotation of position sensors, and so of the body of the vehicle. In some embodiments, the trajectory may be reconstructed based on data from inertial sensors, such as accelerometer, and the velocity of vehicle 1510 sensed by a speed sensor. In addition, in some embodiments, the trajectory may be determined (e.g., by a processor onboard each of vehicles 1510-1550) based on sensed ego motion of the camera, which may indicate three-dimensional translation and/or three-dimensional rotations (or rotational motions). The ego motion of the camera (and hence the vehicle body) may be determined from analysis of one or more images captured by the camera.

In some embodiments, the trajectory of vehicle 1510 may be determined by a processor provided aboard vehicle 1510 and transmitted to server 1560. In other embodiments, server 1560 may receive data sensed by the various sensors and devices provided in vehicle 1510, and determine the trajectory based on the data received from vehicle 1510.

In some embodiments, the navigation information transmitted from vehicles 1510-1550 to server 1560 may include data regarding the road geometry or profile. The geometry of road segment 1500 may include lane structure and/or landmarks. The lane structure may include the total number of lanes of road segment 1500, the type of lanes (e.g., one-way lane, two-way lane, driving lane, passing lane, etc.), markings on lanes, width of lanes, etc. In some embodiments, the navigation information may include a lane assignment, e.g., which lane of a plurality of lanes a vehicle is traveling in. For example, the lane assignment may be associated with a numerical value “3” indicating that the vehicle is traveling on the third lane from the left or right. As another example, the lane assignment may be associated with a text value “center lane” indicating the vehicle is traveling on the center lane.

Server 1560 may store the navigation information on a non-transitory computer-readable medium, such as a hard drive, a compact disc, a tape, a memory, etc. Server 1560 may generate (e.g., through a processor included in server 1560) at least a portion of an autonomous vehicle road navigation model for the common road segment 1500 based on the navigation information received from the plurality of vehicles 1510-1550. Server 1560 may determine a trajectory associated with each lane based on crowd sourced data (e.g., navigation information) received from multiple vehicles (e.g., 1510-1550) that travel on a lane of road segment at different times. Server 1560 may generate the autonomous vehicle road navigation model or a portion of the model (e.g., an updated portion) based on a plurality of trajectories determined based on the crowd sourced navigation data. Server 1560 may transmit the model or the updated portion of the model to one or more of autonomous vehicles 1510-1550 traveling on road segment 1500 or any other autonomous vehicles that travel on road segment at a later time for updating an existing autonomous vehicle road navigation model provided in a navigation system of the vehicles. The autonomous vehicle road navigation model may be used by the autonomous vehicles in autonomously navigating along the common road segment 1500.

With regard to placing or removing markings on a pavement segment, new coordinate data can be appended to the data set through normal operation of the pavement segment marking or removal equipment. For example, when removal equipment is used to remove temporary markings, this can be equipped with the same precision GPS equipment as the pavement marking equipment. These coordinates could then be used to “remove” their digital analog as well. In one example, where a lane that has been shifted left needs to be extended, the portion of the markings that denote the return to normal lane lines can be removed via the input from the removal equipment. The addition of more temporary markings to extend the shifted lane would then be appended to this data set, resulting in a new roadmap that continues to match the real-world layout.

In embodiments where the drive vectors represent navigation through a temporary work zone, the dataset must be updated when the work zone has been completely removed. This remote server must be updated to reflect this, and notifications of this updated change may be made available to vehicles.

A vehicle may continuously share its location with the remote server. In this example, when the vehicle is within the vicinity of a noteworthy pavement segment, such as a work zone, the remote server transmits the most appropriate drive vectors for the upcoming work zone. These are then downloaded to the vehicle and used for assisting the existing navigation systems route through the work zone.

The vehicle may be an autonomous vehicle or a traditional, primarily human-controlled vehicle. The autonomous vehicle road navigation model may include a plurality of target trajectories representing preferred paths of travel along particular pavement segments. Alternatively, the vehicle storage device may store only portions of the drive vector data (e.g., the current road for 10 miles) with the server providing additional data to the navigating vehicle as needed. In such embodiments, the local maps may be stored only temporarily in the storage device and may be purged from the storage device upon receipt of one or more newly received local maps or after a vehicle is determined to have exited a particular navigational area or zone.

The server may identify model changes, such as construction, detours, new signs, or removed signs, based on data received from the vehicles. The server may continuously or periodically update the model upon receiving new data from the vehicles. The server may distribute updates to the model or the updated model to vehicles for providing autonomous navigation.

### 9. CAV Navigation Using Lane Markings

For a vehicle driving autonomously, construction zones may be challenging to transverse. The following discloses how high-precision location data can be used to designate “virtual” pavement segment lines for autonomous vehicle navigation. This is especially important in construction zones, where visual clues are often confusing, and lane location can change drastically with minimal warning.

As previously discussed in relation to FIG. 2, an exemplary CAV system may include various components depending on the requirements and use case of the systems use. In some embodiments, the system might include a processor, user interface, computer memory, a position sensor, and an inertial measurement unit. The processing unit may include one or more processing devices.

The system may also include a data interface for connecting the computing device to the internet. For example, a data interface may include any wired and/or wireless link or links for transmitting captured data from a sensor, processor, or computer to a remote server. The wireless transceiver may include one or more devices configured to exchange transmissions over an air interface to one or more networks (e.g., cellular, the Internet, etc.) by use of a radio frequency, infrared frequency, magnetic field, or an electric field. The wireless transceiver may use any known standard to transmit and/or receive data, including but not limited to Wi-Fi, Bluetooth®, Bluetooth Smart, 802.15.4, and ZigBee.

The system may include any types of non-transitory storage devices or computer-readable media, or memory. For example, in some embodiments, memory may include magnetic storage media such as hard drives or tapes; optical storage media such as compact discs or DVDs; solid state storage media such as solid state drives and so-called “flash” storage devices such as USB or “thumb” drives; or any other suitable storage media. In some embodiments the collected data may be stored in a database that may be stored in memory, or other types of storage devices.

The position sensor may include any type of device suitable for determining a location associated with at least one component of the system. The position sensor may obtain data representing the absolute or geographical location of the system component, and/or the relative location of the system including but not limited to data regarding movement of the component and/or of a mobile platform or vehicle associated with the system component. For example, the position sensor may obtain data from one or more of a Global Navigation Satellite System (GNSS) receiver such as a Global Positioning System receiver; a real-time kinetic (RTK) system; an inertial measurement unit (IMU); an inertial navigation system (INS); a total station system; an accelerometer; a gyroscope; or a drive shaft or other rotary encoder. Position information from the position sensor may be made available to the computing device. In some embodiments, this position sensor is used for determining the location of the pavement segments themselves, either with or without correction. The present application may include an apparatus for inputting raw GPS positional data (which may also include RTK enhanced raw GPS positional data), along with data derived from one or more additional position sensors along with a kinematic model (i.e., a model based on the physical laws of motion) of the vehicle, into a Bayesian model-based filter to fuse this data to achieve a more accurate GPS geographical location data of both the vehicle and pavement segment.

Additional sensors or inputs might include inputs from marking application or removal equipment. In these embodiments, the system associates the data from the position sensor with this equipment data to further enrich the marking pattern data. For example, a paint truck equipped with this system could provide the paint gun “on/off” data to the computing device, so that the marking pattern, such as double yellow no passing, is also associated with the location data from the position sensor. For marking (as well as for removal and data collection) a GNSS antenna may be associated with a pavement segment alignment module by being mounted on the module at the point where the module is intended to be aligned with a pavement segment; by being mounted on the module at a known distance from the point where the module is intended to be aligned with a pavement segment; or by being mounted on the vehicle or mobile platform to which a pavement segment alignment module is attached, at a known distance from the point where the module is intended to be aligned with a pavement segment. The operator then applies the markings as per usual; however, with this additional equipment, a digital analog of the marking location is captured at the same time as the physical marking application. By either mounting this antenna directly over the marking application gun, or at a known lateral distance which is then used to correct for the true GPS coordinates of the marking, the GPS coordinates for the actual marking are able to be captured. For high precision capture, a GPS apparatus with multiple antennas and a plurality of sensors may be used.

The data stored in memory may include drive vector data, while in other embodiments drive vector data may be determined in a remote server or processor. The drive vector data may represent, or be used to provide an autonomous navigation system with, a target trajectory representing an ideal path that a vehicle should follow along a pavement segment. The target trajectory may be located, for example, at an approximate center of a lane of travel. In other cases, the target trajectory may be located elsewhere relative to a pavement segment. For example, a target trajectory may approximately coincide with a center of a road, an edge of a road, or an edge of a lane. In such cases, navigation based on the target trajectory may include a determined amount of offset to be maintained relative to the location of the target trajectory. Moreover, in some embodiments, the determined amount of offset to be maintained relative to the location of the target trajectory may differ based on the type of vehicle; for example, a passenger vehicle including two axles may have a different offset from a truck including more than two axles along at least a portion of the target trajectory.

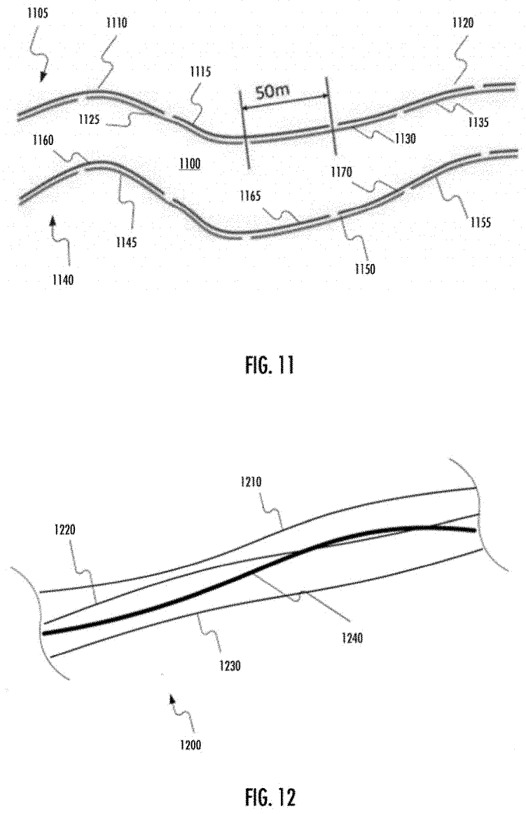

In some situations, a single lane of a road may be modeled by a three-dimensional polynomial description of left and right sides of the road. Such polynomials representing left and right sides of a single lane are shown in FIG. 11. The calculation of these polynomials is capable by those of ordinary skill in the art using non-Euclidean geometry. For example, calculations for determining these polynomials on a non-planar surface may be performed using non-Euclidean geometry taking into account elements such as radius of curvature and/or pitch of a pavement segment. Regardless of how many lanes a road may have, the road may be represented using polynomials in a way similar to that illustrated in FIG. 11. For example, left and right sides of a multi-lane road may be represented by polynomials similar to those shown in FIG. 11, and intermediate lane markings included on a multi-lane road (e.g., dashed markings representing lane boundaries, solid yellow lines representing boundaries between lanes traveling in different directions, etc.) may also be represented using polynomials such as those shown in FIG. 11.

As shown in FIG. 11, a lane 1100 may be represented using polynomials (e.g., a first order, second order, third order, or any suitable order polynomials). For illustration, lane 1100 is shown as a two-dimensional lane and the polynomials are shown as two-dimensional polynomials. Lane 1100 includes a left side 1105 and a right side 1140. In some embodiments, more than one polynomial may be used to represent a location of each side of the road or lane boundary. For example, each of left side 1105 and right side 1140 may be represented by a plurality of polynomials of any suitable length. In some cases, the polynomials may have a length of about 100 m, although other lengths greater than or less than 100 m may also be used. Additionally, the polynomials can overlap with one another in order to facilitate seamless transitions in navigating based on subsequently encountered polynomials as a host vehicle travels along a roadway. For example, each of left side 1105 and right side 1140 may be represented by a plurality of third order polynomials separated into segments of about 100 meters in length (an example of the first predetermined range), and overlapping each other by about 50 meters. The polynomials representing the left side 1105 and the right side 1140 may or may not have the same order. For example, in some embodiments, some polynomials may be second order polynomials, some may be third order polynomials, and some may be fourth order polynomials.

In the example shown in FIG. 11, left side 1105 of lane 900 is represented by two groups of third order polynomials. The first group includes polynomial segments 1110, 1115, and 1120. The second group includes polynomial segments 1125, 1130, and 1135. The two groups, while substantially parallel to each other, follow the locations of their respective sides of the road. Polynomial segments 1110, 1115, 1120, 1125, 1130, and 1135 have a length of about 100 meters and overlap adjacent segments in the series by about 50 meters. As noted previously, however, polynomials of different lengths and different overlap amounts may also be used. For example, the polynomials may have lengths of 500 m, 1 km, or more, and the overlap amount may vary from 0 to 50 m, 50 m to 100 m, or greater than 100 m. Additionally, while FIG. 11 is shown as representing polynomials extending in 2D space (e.g., on the surface of the paper), it is to be understood that these polynomials may represent curves extending in three dimensions (e.g., including a height component) to represent elevation changes in a pavement segment in addition to X-Y curvature. In the example shown in FIG. 11, right side 1140 of lane 1100 is further represented by a first group having polynomial segments 1145, 1150, and 1155 and a second group having polynomial segments 1160, 1165, and 1170.

### 10. Assessment and Modification of Pavement Segments

Markings may be made up of a wide variety of chemical compositions, including latex paint and epoxy compounds. They can vary in durability, thickness, and performance. All pavement surface markings will fail over time due to wear, but some may fail within a single year due to environmental conditions and high traffic. Improper material application or poor retroreflective bead embedment is a frequent cause of marking failure. Additionally, markings may become less efficient or completely ineffective in snow, ice, or heavy rain.

Markings are prone to failure for a variety of reasons, with failure defined as the inability to convey correct information to the intended receiver, whether human or mechanical, under the applicable travel conditions. Failure therefore includes inadequate retro-reflectivity levels to convey that information for travel under sub-optimal lighting conditions, including those caused by weather as well as during nighttime.

Markings have a life cycle which includes at least three phases; assessing, marking, and removing. Assessing includes obtaining a representation of the current state of a pavement segment, and may relate to, for example, whether paint is present or absent on a portion of a pavement segment; the condition of paint that is present on a pavement segment; the retro-reflectivity of a pavement segment; the presence or absence of pavement segment contaminants, such as rubber marks from vehicle wheels; the presence or absence of foreign objects on or adjacent to a pavement segment; the presence or absence of structural flaws in a pavement segment, such as cracks or potholes; and the presence, type, and status of elements ambient to pavement segments such as vegetation, landscaping, lighting, signage, and fences. Marking a pavement segment includes placing a marking material, such as paint and/or a reflective material such as glass beads, on the pavement surface. Removal includes removing contaminants from a pavement surface, such as rubber from vehicle wheels and/or foreign object debris, or markings that are no longer needed or need to be replaced/renewed. Marking a pavement segment and removal of markings from a pavement segment may be collectively referred to herein as pavement segment modification.

Assessment, marking, and removal may be carried out on a pavement segment using a mobile platform capable of being positioned onto pavement, moved to a location on pavement, and removed from pavement. As used herein, a “mobile platform” is an apparatus whose design includes the ability to move or be moved by a motive force, which may be provided by an internal combustion, diesel, or electric motor or engine; by hydraulic or pneumatic mechanisms; by air propulsion such as that provided by a propeller, fan, or rotor; by a human pushing or carrying the apparatus; or by any other appropriate mechanism; and, which has the capability to assess and/or modify a pavement surface. A mobile platform may be associated with a vehicle, such as a paint module or carriage associated with a paint truck, an assessment module associated with a van, or a pressure-washing module associated with a truck; may itself be a vehicle; or may be a mobile device pushed or carried by a human, such as a walk-behind or other hand-propelled apparatus, or a smartphone or other hand-held apparatus. A mobile platform may include a pavement segment alignment module, which means a component whose function includes being placed in alignment with, or in alignment in relation to, a pavement segment that is to be assessed or modified, as by the placing or removal of marks. A pavement segment alignment module may be capable of being aligned with a pavement segment by moving independently of a vehicle or mobile platform with which it is associated, including being movable with or along a boom such as a paint carriage or a paint gun/paint gun assembly on a paint truck, or may be aligned with a pavement segment by movement of the vehicle or mobile platform with which it is associated. A pavement segment alignment module may be used, for example, in connection with collecting data or controlling the position and/or operation of a paint carriage or a marking removal module. A mobile platform may operate at least partially autonomously in assessing or modifying pavement segment markings, and for such operation requires precise location data relating to the subject pavement segment.

Such location data may be used to, for example, determine a starting or current position for a mobile platform, or how much a mobile platform moves in a given direction. Location information may be associated with other data gathered using the mobile platform, such as the location of a marking needing removal or replacement. In addition to a primary controller, other components of a mobile platform may therefore include one or more location systems such as a global positioning system (GPS), real-time kinetic (RTK) positioning system, inertial navigation systems (INS), or total station. These systems may provide location information for the proper positioning and operation of the mobile platform, such as the location of pavement perimeters or areas, or of markings that are to be placed or are currently in existence.

Mobile platform components may include one or more of: an image sensor, retro-reflectometer, or other condition sensor to receive data indicative of a condition of a pavement segment and/or an ambient environment; a motor for controlling a paint carriage; an electronically controlled proportional hydraulic valve; a pressurized air control or other system for controlling the dispensing of materials including paint, reflective beads, water, or chemicals; a paint module position sensor for determining the position of a paint carriage, including “smart cylinder” technology; a speed sensor for determining the speed of the mobile platform and/or associated vehicle; a source of illumination for illuminating the pavement segment; a housing, shroud, or other suitable form of electromagnetic radiation shielding (which may be referred to herein as a “mobile light room”) to reduce the effect of ambient electromagnetic radiation on the condition sensor; a laser for assisting with the alignment of a paint carriage and other tasks; a wireless transceiver for transmitting and/or receiving data (including software update data) to and from a local or remote computing platform, including a cloud computing platform; a drive shaft encoder or other means for determining an accurate distance and speed of a mobile platform; a synchronization system for synchronizing the images of a pavement segment mark with a location and/or time stamp; and other system components.

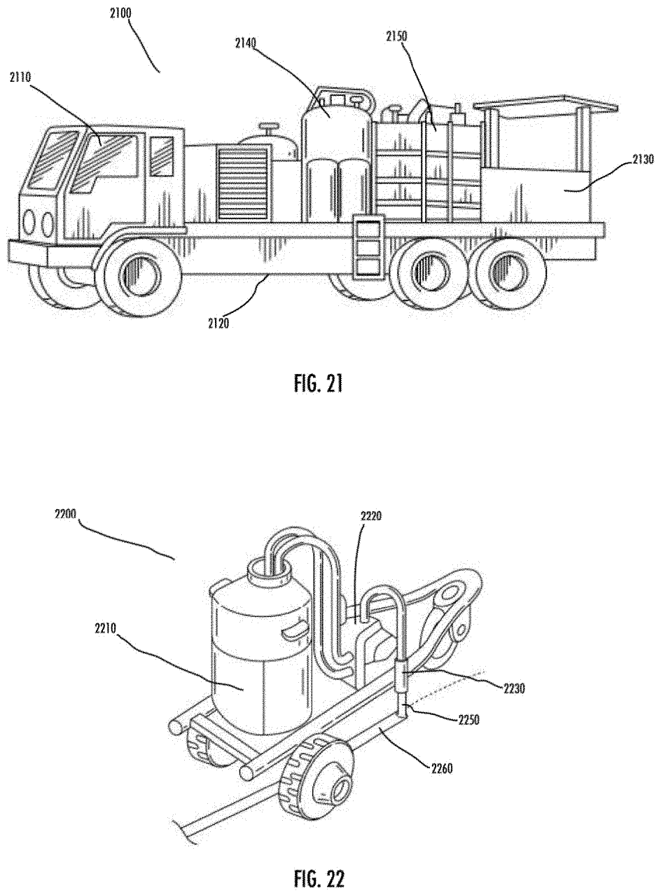

FIG. 21 presents an embodiment of mobile platform 2100 for marking, represented by a truck which includes driver cab 2110 in front, main body 2120, and operator cab or platform 2130 in back. Main body 2120 carries paint source 2140 and reflective bead source 2150, which are placed on the pavement using a paint carriage (not shown).

Boom mast 2725 and beam 2730 are used to carry carriage motor 2735, which is connected to paint carriage 2745 via boom 2740. Paint carriage 2745 includes spray heads 2750, through which material is ejected towards the pavement surface.

FIG. 22 presents an embodiment of mobile platform 2200 for marking, represented by a self-propelled vehicle such as a walk-behind vehicle. Mobile platform 2200 includes material source 2210, which may for example be paint or reflective beads 2240. Paint or reflective beads 2240 are directed towards the pavement surface through spray head 2230 using pump 2220, to produce marking 2250.

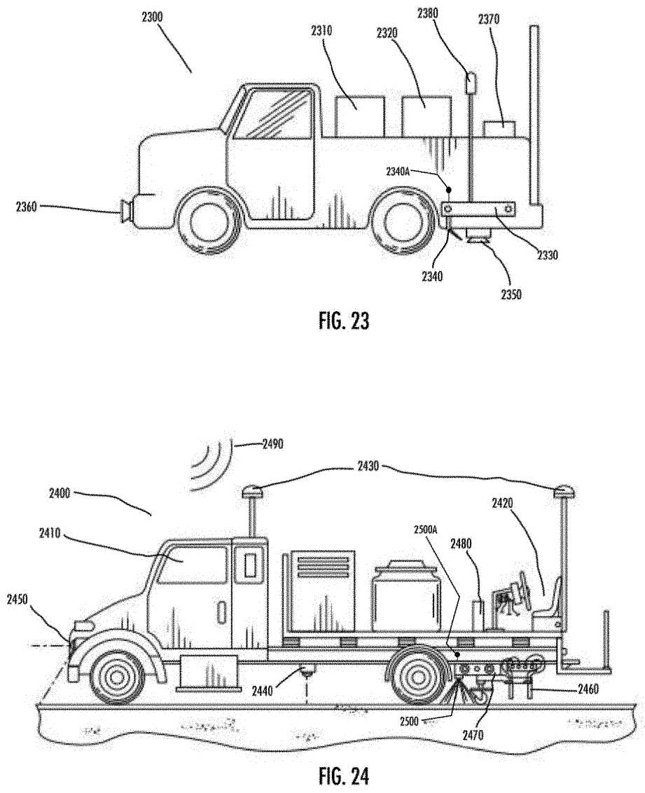

FIG. 23 presents an embodiment of mobile platform 2300 for marking. Mobile platform 2300, represented as a truck, includes materials source 2310, pumping system 2320, and movable platform or paint carriage 2330, which may also represent a pavement segment alignment module. Movable platform or paint carriage 2330 includes spray head system 2340 and GNSS module 2340A. Spray head system 2340. Mobile platform 2300 is further provided with first condition sensor 2350 and, optionally, second condition sensor 2360. Computing platform 2370 is provided to process data received from the first and/or second condition sensors. Additional position sensor 2380 may be used to provide additional location data, which may be associated with data from GNSS module 2340A, and/or may be used to track the location of mobile platform 2300.

FIG. 24 presents an embodiment of mobile platform 2400 for marking, represented by a truck. Mobile platform 2400 may include cab 2410 in front for a driver, and operator station 2420 in back. Operator station 2420 may be used to control aspects of the marking operation other than driving the truck, such as operation of spray head array 2460 and movable cross-track carriage 2470, which may also represent a pavement segment alignment module, on which spray head array 2460 is mounted. Spray head array 2460 includes paint gun or spray head 2500 and GNSS module 2500A. First condition sensor 2440, and optionally second condition sensor 2450, provide data on the pavement surface to local computing platform 2480 and/or to remote computing platform 2490, which may be a cloud computing platform. One or more additional position sensors 2430 may be used to provide location data, which may be associated with data from GNSS module 2500A (and/or data from additional condition sensors), and/or may be used to track the location of mobile platform 2400.

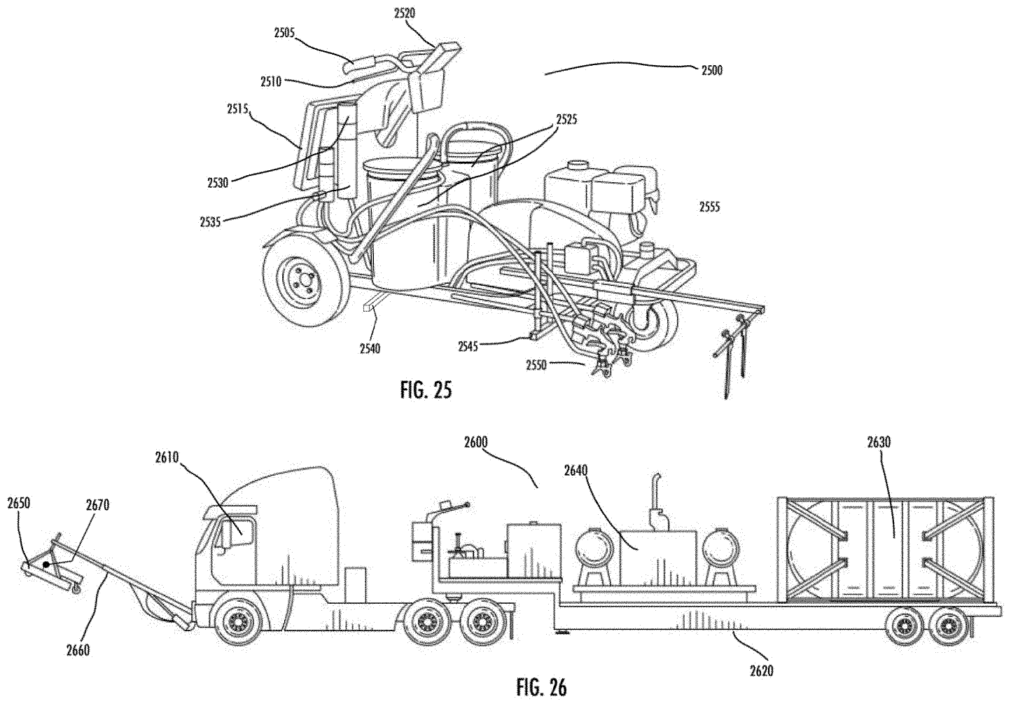

FIG. 25 presents an embodiment of mobile platform 2500 for marking in the form of a walk-behind or ride-on self-propelled vehicle. Mobile platform 2400 may include handlebar 2505, marking material placement controls 2510, dashboard 2515, display 2520, and engine 2555. The main body of mobile platform 2500 may carry marking material sources 2525, hydraulic motor system 2530, and pump system 2535 by which marking materials are ejected towards the pavement surface via spray head system 2550. Rear spray head mounting system 2540 and/or front spray head mounting system 2545 may be provided for the mounting of respective rear and/or front spray head systems, and/or to mount additional components as desired, and may represent pavement segment alignment modules.

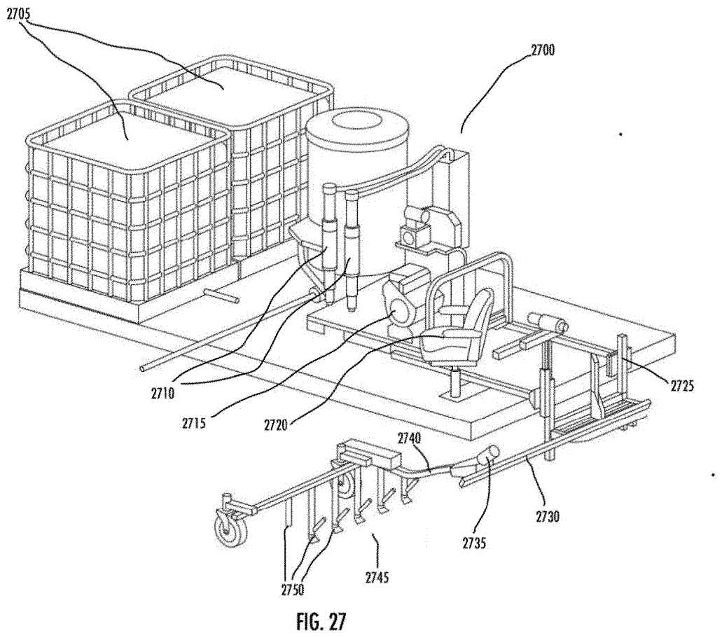

FIG. 26 presents an example of a mobile platform 2600, shown here in the form of a truck, that may be used in the removal process. Mobile platform 2600 includes removal module 2650, which may also represent a pavement segment alignment module bearing GNSS module 2670; cab 2610; and trailer or main body 2620. Trailer or main body 2620 is provided with material source 2630, which may be water, chemicals, or any other fluid or fluidizable material, and with pump system 2640 to move the material from material source 2630 to removal module 2650. Removal module 2650 may be carried by a movable boom 2660, which enables placement of the removal platform as desired. Removal module 2650 may include a spray head assembly through which material is ejected at sufficiently high pressure to accomplish the desired removal process which, by way of non-limiting example, may involve removing paint markings or rubber markings. Removal module 2650 may also include or be accompanied by a recovery module operable to recover material that has been ejected onto the pavement surface, and which may include paint and/or rubber removed by this process.

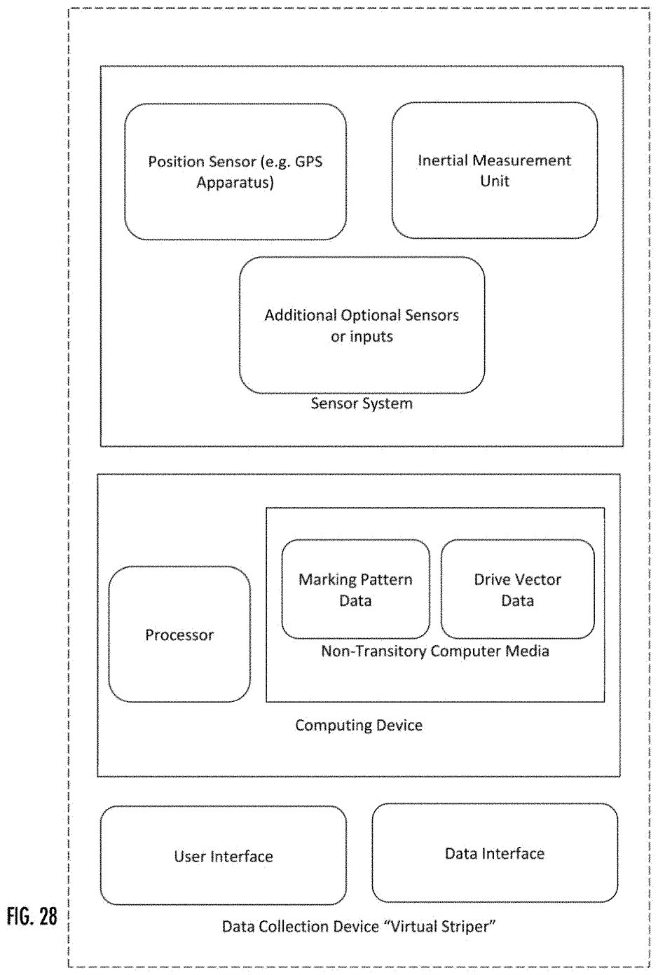

FIG. 27 presents an embodiment of mobile platform 2700 for marking which, as depicted, would be a module associated with a vehicle. Mobile platform 2700 includes materials sources 2705, from which material is moved by pumps 2710 and pump motor 2715. Control and/or monitoring of the operation of mobile platform 2700 may take place via operator station 2720. Boom mast 2725 and beam 2730 are used to carry carriage motor 2735, which is connected to paint carriage 2745 via boom 2740. Paint carriage 2745 includes spray heads 2750, through which material is ejected towards the pavement surface.

### 11. Use of VMX Data in Pavement Segment Marking

In paint trucks and other vehicles used to place markings on pavement segments, a paint control system determines when paint guns turn on and off. Because this is controlled by the same system as the VMX capture, the data captured during marking includes the color of the marking, the pattern being marked, and the location of the marking.

For example, the association between one paint gun turning on and off, with a second paint gun mapped to its right painting continuously, may be used to identify a one-direction no-passing zone marking consisting of a double yellow line, one of which is a normal broken yellow line and the other of which is a normal solid yellow line. This marking may be used to indicate that crossing the center line markings for passing with care is permitted for the traffic traveling adjacent to the broken line, but is prohibited for traffic traveling adjacent to the solid line.

### 12. Pavement Segment Marking—Virtual

The collection of pavement segment marking location data via the present system can be performed independent of marking application or removal. In one embodiment, the system may be used on a standard vehicle driven by a human operator.

With reference to FIG. 28, the exemplary data collection system, referred to for purposes of convenience only as a “Virtual Striper”, may include a sensor system having a position sensor, such as a GNSS sensor; an inertial measurement unit; and additional sensors and/or inputs. The system may further include a computing device with a processor, and non-transitory computer media in which marking pattern data and drive vector data is stored, and which is accessible via a user and data interfaces.

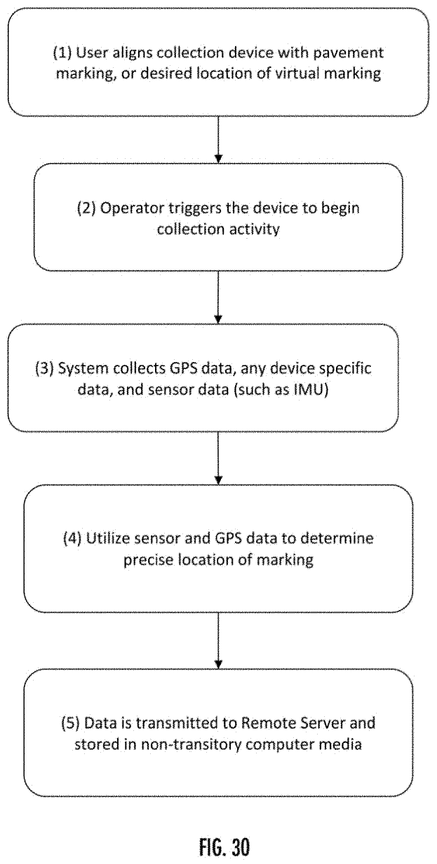

With reference to FIG. 30, an operator might (1) align a collection device, such as a GPS antenna, with the pavement segment marking. (2) The operator then triggers the device to begin collecting data. At this stage the operator would manually enter any relevant data such as marking pattern, direction of travel, road name, and so on via the user interface. (3) The present system would begin logging all available data from the various information sources and sensors. As the operator navigates along the length of the marking, the system continues to log the data, gathering a trail of information for the duration of the measurement. (4) Whether during or following the collection, the data from the various sources is then used to determine the precise location of the markings. The system may use a Bayesian model-based filter which accounts for the raw geographical location of the GPS antenna and the data collected by the plurality of sensors. (4) Lastly, this data is transmitted to the remote server via a wireless transceiver which may include one or more devices configured to exchange transmissions over an air interface to one or more networks (e.g., cellular, the Internet) by use of a radio frequency, infrared frequency, magnetic field, or an electric field. The wireless transceiver may use any known standard to transmit and/or receive data, as previously discussed.

### 13. Capturing VMX Data via Paint Truck Operation in a Work Zone

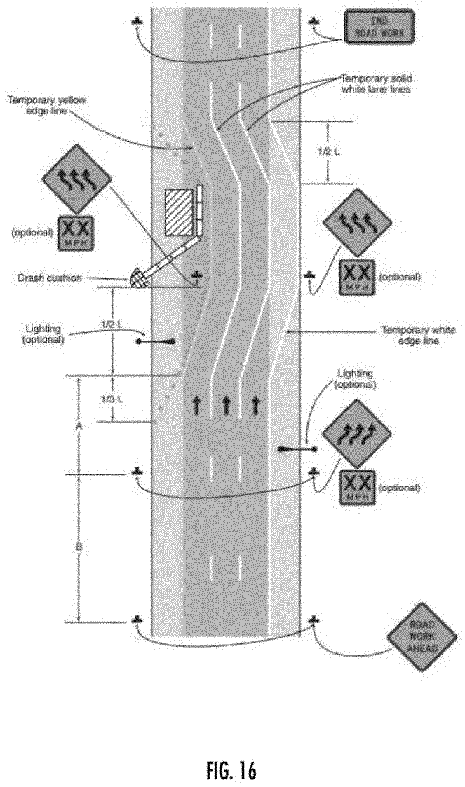

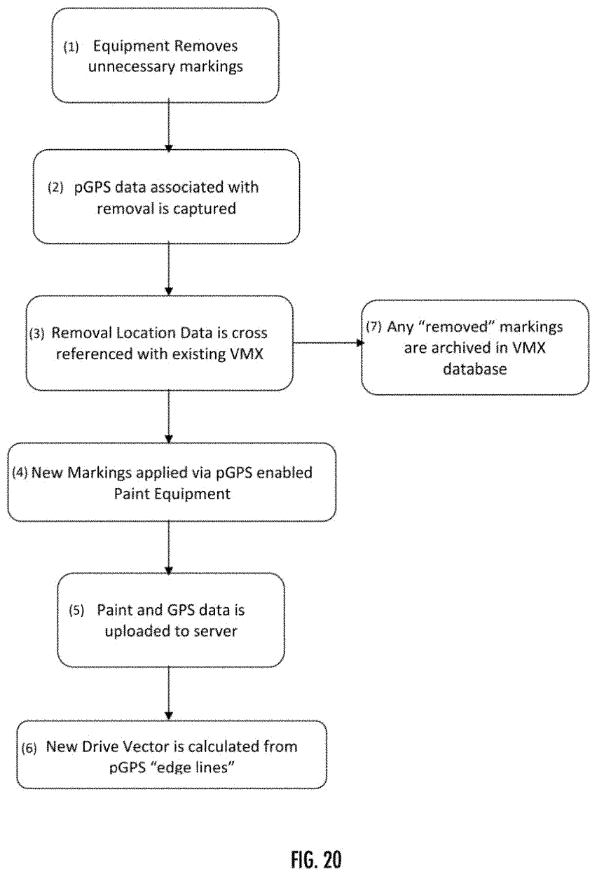

The Manual on Uniform Traffic Control Devices (MUTCD), Part 6, details the methods and equipment for Temporary Traffic Control (TTC), such as establishing a work zone on an active road or highway. These methods include a lane shift on a freeway, as described in the MUTCD, Typical Application 36, Lane Shift on a Freeway, as visualized graphically in FIG. 6H-36, shown in FIG. 16.

For purposes of the present system, work zone preparation would begin with workers setting up the work zone as they normally would, per the guidance provided in the MUTCD. This includes placing the required signage, arrow boards, and channelizing devices (such as traffic cones) as necessary to establish the work zone. When a lane shift on a freeway is necessary, the guidance requires the removal of existing markings, and the application of new temporary markings and/or of channeling devices such as cones or other barricades.

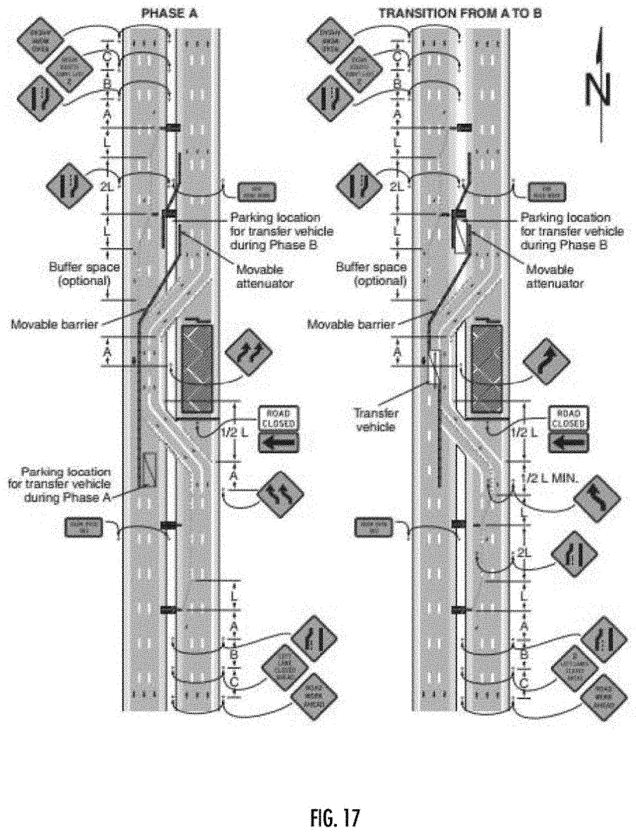

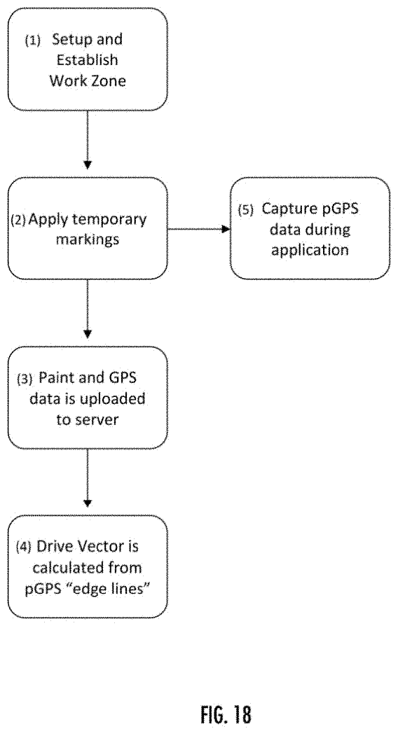

Under the present system a high-precision GPS apparatus is used, as described herein, to capture desired VMX location data of the temporary markings and/or of the channeling devices; the data may be captured during the process of placing the markings or devices, or afterwards. This VMX location data may be used to produce a 2D roadmap, an example of which is shown in FIG. 17, indicating one or more drive vectors for passage through the work zone.

This 2D roadmap can be shared with CAVs to be used for improved navigation through the work zone. This VMX data can be used in addition to existing navigation systems and sensors for an increased level of precision while traversing the work zone.

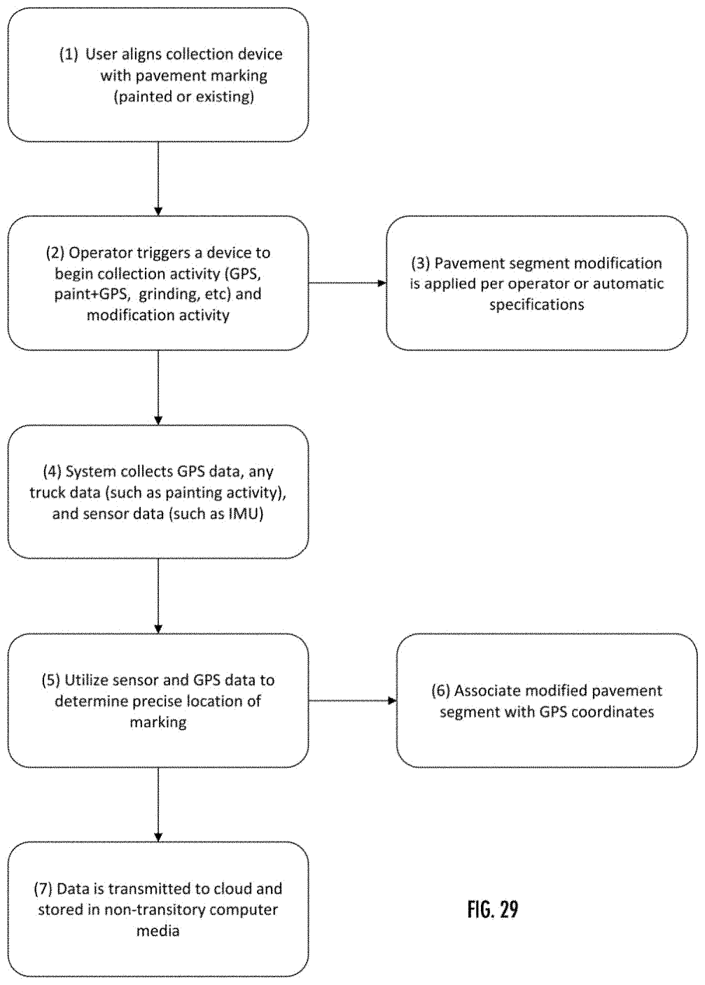

FIG. 29 provides approach to capturing VMX data during the process of modifying a pavement segment, as by painting or removal of markings. Here, an operator might (1) align a collection device, such as a GPS antenna, with the pavement segment marking. (2) The operator then triggers the device to both begin collecting data, and initiate modification of the pavement segment. At this stage the operator would manually enter any relevant data such as marking pattern, direction of travel, road name, and so on via the user interface. (3) Depending on the modification being carried out, painting, removal, or other modification is applied to the pavement segment. (4) The present system would begin logging all available data from the various information sources and sensors, including marking, removal, or other modification data. As the operator navigates along the length of the marking, the system continues to log the data, gathering a trail of information for the duration of the measurement. (5) Whether during or following the collection, the data from the various sources is then used to determine the precise location of the markings or other modification. The system may use a Bayesian model-based filter which accounts for the raw geographical location of the GPS antenna and the data collected by the plurality of sensors. (6) The location of the modified pavement segment is associated with location/position information, such as GPS coordinates. (7) Lastly, this data is transmitted to the remote server via a wireless transceiver which may include one or more devices configured to exchange transmissions over an air interface to one or more networks (e.g., cellular, the Internet) by use of a radio frequency, infrared frequency, magnetic field, or an electric field. As previously discussed, the wireless transceiver may use any known standard to transmit and/or receive data, including but not limited to P2P, V2V, Wi-Fi, Bluetooth®, Bluetooth Smart, 802.15.4, ZigBee, and cellular including 5G.

The present disclosure includes a pavement segment location data collection system for obtaining VMX data as described herein. Such data may be obtained without using the system to perform any pavement segment modification, and the system may not include any pavement segment modification capability. One example of such a pavement segment location data collection system includes a pavement segment alignment portion to be aligned with a pavement segment for which VMX data is desired. The system also includes a GNSS module and at least one additional position sensor. The GNSS module and additional position sensor are configured to provide location data to at least one processor. The at least one processor uses the location data to (a) calculate a location of the pavement segment alignment module; (b) using the location of the pavement segment alignment module, calculate a location of the pavement segment; and (c) using the location of the pavement segment, calculate, using non-Euclidean geometry, a polynomial representation of a trajectory that can be used by a connected and autonomous vehicle in navigating the pavement segment. In order to use the system, the pavement segment alignment module is aligned with a pavement segment; the data collection system is activated to initiate calculation of the location of the pavement segment and of the polynomial representation of a trajectory that can be used by a connected and autonomous vehicle in navigating the pavement segment; and at least one of the location of the pavement segment, and the polynomial representation of a navigation trajectory, is transmitted to non-transitory computer-readable storage media, which may be local to or remote from the pavement segment data collection system.

14. Modifying/Updating a Work Zone with VMX Data

If a work zone needs to be changed or updated, the corresponding VMX data must also be modified to match. For example, if a work zone is extended, the newly added work zone data will need to be added. This highlights the need for the ability to not only read and write, but also update and delete VMX data from the dataset.

This would also be necessary for work zones which have temporary and changing directions of travel, such as is noted in Typical Application 45 of the MUTCD (see FIG. 17). As noted in the advisory, “In this example, one side of a 6-lane divided highway is closed to perform the work operation, and vehicular traffic is carried in both directions on the remaining 3-lane roadway by means of a median crossover. To accommodate unbalanced peak-period vehicular traffic volumes, the direction of travel in the center lane is switched to the direction having the greater volume, with the transfer typically being made twice daily.” In this example, the VMX roadmap would also need to adapt the Drive Vector to reflect the change in direction of the shared lane. Preferably, determination of the current direction of travel of a shared lane should include observational data such as optical capture of a sign or channeling devices, with the VMX data used for positioning of the edge and center of the lane, regardless of direction of travel.

15. Using Captured VMX Data from a Work Zone for CAV Navigation

As described above, the VMX data can be shared with a CAV in a number of ways. Once obtained by the CAV, the data can be used by in-vehicle navigation systems to simplify route optimization calculations. For example, the predetermined drive vector can be used by the CAV to map an expected route through the work zone. The vehicle can then use on-vehicle sensors, such as image or LiDAR, to update this route, rather than having to determine the route from scratch. One example of how such a process might operate is as follows:
1. The CAV approaches a work zone and acquires the VMX data by one of the methods described above. The navigation system is now starting with a predetermined route through the work zone based on the locations of the temporary markings that have been applied when the work zone was created.
2. In this example, a two-lane road has been shifted left, as in the MUTCD example in FIG. 16. A vehicle traveling in the left lane would be using the left edge line, right edge line, and drive vector for that specific lane. Centering on the drive vector, the vehicle would have the precise coordinates of when and where the lane shift occurs, and thus follow the drive vector into the shifted lane.
3. By centering on the drive vector, but still having the left and right edge lines as references, the vehicle can safely respond to any real-world conditions, such as a stray traffic cone, without leaving the lane.
4. The vehicle begins to transverse the work zone based on the route mapped by the VMX drive vector. Per normal operation, the on-vehicle sensors continue to provide environmental details such as the actual locations of channeling devices or roadside signage. This is to assure that the vehicle still responds to real-world conditions, such as a traffic cone that has been knocked into the lane or a stray piece of equipment.
5. As the vehicle exits the work zone, any real-world conditions that were observed which deviate from those captured in the VMX roadmap are conveyed back to an on-site communication device. This information can then be used for updating the VMX roadmap for future vehicle navigation.
6. When the vehicle no longer has VMX coordinate data and has either passed the on-site communications device, or confirmed via location that it has exited the work zone, it then resumes normal navigation.

### 16. Special Case: Temporary VMX Road Closure by Public Safety Vehicle

When a public safety vehicle is stationary on or adjacent to a pavement segment, such as having pulled over to the side of the road, safety can be increased with the use of ad-hoc geofencing via the same VMX mechanisms as described elsewhere herein. For example, a police officer pulls a driver over to the right side shoulder of an interstate. Prior to exiting the vehicle, the officer engages a VMX geofence. This uses the precise location of the public safety vehicle (determined, for example, via high-precision RTK GNSS) to calculate a geo-fence surrounding the public safety vehicle. This can be a configurable size based on user preferences, but should consist of a “bubble” that is large enough to allow safe navigation around the perimeter of the vehicle.

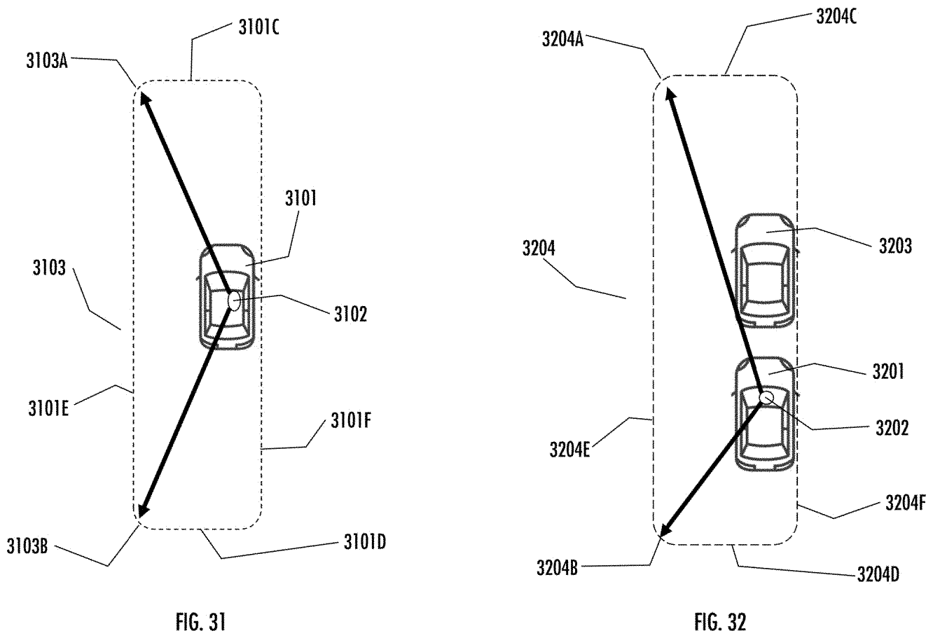

FIG. 31 is a top perspective view of one example of the situation described above, in which vehicle 3101, which may be a law enforcement or other vehicle, is stationary on or adjacent the edge or shoulder of a roadway. GNSS transceiver 3102 is used to create a boundary or geofence 3103 extending, as shown by way of example only, behind, in front of, and to the left of vehicle 3101. Geofence 3103 may include first corner 3103A, second corner 3103B, top or upper boundary 3103C, bottom or lower boundary 3103D, left boundary 3103E, and right boundary 3103F. (It is understood that terms such as behind, in front of, left, top, upper, bottom, lower, left, and right are used here in a relative sense only.) The specific boundaries and/or size of geofence 3103 may of course vary from those shown, and may be pre-programmed into GNSS transceiver 3102, manually selectable from a user interface in vehicle 3101, or established by a person walking a perimeter around vehicle 3101 holding a mobile device that communicates with GNSS transceiver 3102.

In another embodiment, the law enforcement officer or other driver may opt to extend or elongate the geofence in any direction of the vehicle, including to enclose a second vehicle as shown in FIG. 32. Here, first vehicle 3201 represents a law enforcement vehicle containing GNSS transceiver 3202, and second vehicle 3203 represents a car that has been pulled to the edge or shoulder of a roadway by the law enforcement vehicle. As with the preceding example, GNSS transceiver 3202 is used to create a boundary or geofence 3204 extending, as shown by way of example only, behind, in front of, and to the left of vehicles 3201 and 3202. Geofence 3204 may include first corner 3204A, second corner 3204B, top or upper boundary 3204C, bottom or lower boundary 3204D, left boundary 3204E, and right boundary 3204F. (Also as in the preceding example, it is understood that terms such as behind, in front of, left, top, upper, bottom, lower, left, and right are used here in a relative sense only.) The specific boundaries and/or size of geofence 3204 may also vary from those shown, and may be pre-programmed into GNSS transceiver 3202, manually selectable from a user interface in vehicle 3201, or established by a person walking a perimeter around vehicle 3201 holding a mobile device that communicates with GNSS transceiver 3202.

Once engaged, the coordinates for such a geo-fence may be synchronized with a VMX cloud database. These coordinates may be referenced against the existing VMX markings, and if the segments overlap, may automatically trigger a suggested temporary lane closure for the lane that is intruded upon. This is shared with CAVs in the area, triggering them to slow down, and/or switch lanes as appropriate.

Should the new geofence not extend into an existing lane, based on the current VMX markings, a notification may still be sent to CAVs, denoting the location of the event on the side of the road, so as to still potentially trigger a reduction in speed, and at the least increasing awareness of the driver and vehicle systems to the situation at that location.

Given that this implementation is entirely digital, it may be desirable to verify the location and status of these markings/geofence using direct visual data. This may be accomplished via a web or native phone application with the VMX coordinates overlaid on a satellite map.

### 17. Special Case: Using VMX Data to Facilitate Movement of Public Safety Vehicles

It can be difficult and time-consuming for a public safety vehicle, such as a police car, ambulance, fire truck, or tow/repair truck, to find passage through normal traffic, and this challenge may be significantly increased in a work zone. If a public safety vehicle is employing visual alerts such as flashing lights, and/or audible alerts such as a siren or horn, CAVs equipped with visual and/or sound sensors may detect the approach of the public safety vehicle using such sensors. If the public safety vehicle is further equipped with a transmitter broadcasting its presence and direction to CAVs along the route it is traveling, those CAVs may be configured to navigate in response in order to create a lane of passage for the public safety vehicle in coordination with each other and the local environment, as well as to then resume travel once the public safety vehicle has passed, including using VMX data on the presence and dimensions of roadway shoulders, signage adjacent the roadway, exit and entry lanes, merge lanes, overpasses, and the like to use available space while avoiding collisions with each other and adjacent features/structures. Similarly, if a life flight helicopter intends to land on or adjacent a roadway in order to transport an injured person or persons from a roadway area, such VMX data may be used by CAVS in that area to navigate in order to open a landing space as close as practicable to the person(s) needing transport.

While the present application makes reference to particular embodiments, it will be understood by those skilled in the art that various changes may be made and equivalents may be substituted for elements thereof without departing from the intended scope. In addition, modifications may be made to adapt a particular situation or material to these teachings without departing from the intended scope. For example, and by way of non-limiting example only, the present teachings may be applied to, among others, pavement segments used or intended for use by aircraft, such as runways; pavement segments of parking garages, including travel lanes, parking spaces, handicapped spaces, and spiral ramps; and to control vehicular traffic for event parking and egress, including coordinating egress when an event ends to avoid gridlock from multiple vehicles attempting to leave at the same time and using the same path.

Therefore, it is intended that the scope not be limited to the particular embodiments disclosed herein, but rather will include all embodiments falling within the scope and spirit of the appended claims.

What I/We claim is:

1. A process for representing the location of a pavement segment, comprising:
a) receiving, by a data collection system, location data from a Global Navigation Satellite System (GNSS) module of a mobile platform and from at least one additional position sensor;
b) using the location data from the GNSS module, calculating a location of a pavement segment alignment module;
c) using the location of the pavement segment alignment module, calculating a location of the pavement segment;
d) using the location of the pavement segment, calculating, using non-Euclidean geometry, a polynomial representation of a trajectory that can be used by a connected and autonomous vehicle in navigating the pavement segment; and,
e) transmitting at least one of the location of the pavement segment and the polynomial representation of a navigation trajectory to non-transitory computer-readable storage media.

2. The process of claim 1, further comprising;
a) aligning the pavement segment alignment module with a pavement segment, and
b) activating the data collection system to initiate calculation of the location of the pavement segment and of the polynomial representation of a trajectory that can be used by a connected and autonomous vehicle in navigating the pavement segment.

3. The process of claim 1, wherein the at least one additional position sensor is configured to receive data from at least one of a real-time kinetic system, an inertial measurement unit, an inertial navigation system, a total station system, an accelerometer, a gyroscope, and a rotary encoder.

4. The process of claim 3, wherein the pavement segment has at least a first edge and the location of the pavement segment includes the location of the first edge.

5. The process of claim 4, wherein the trajectory is calculated as an offset from the first edge of the pavement segment.

6. The process of claim 4, wherein the pavement segment has at least a second edge and the location of the pavement segment includes the location of the second edge.

7. The process of claim 6, wherein the trajectory is calculated as a midpoint between the first edge and the second edge of the pavement segment.

8. The process of claim 3, further comprising using a Bayesian model-based filter to calculate the location of the pavement segment.

9. The process of claim 3, wherein the pavement segment is located in a work zone of a roadway.

10. The process of claim 3, wherein the non-transitory computer-readable storage media is located in a server remote from the mobile platform.

11. The process of claim 10, wherein the non-transitory computer-readable storage media is located in a connected and autonomous vehicle.

12. The process of claim 3, wherein calculation of the location of the pavement segment and of the polynomial representation of a trajectory that can be used by a connected and autonomous vehicle in navigating the pavement segment takes place concurrently with the collection of location data.

13. The process of claim 3, wherein calculation of the location of the pavement segment and of the polynomial representation of a trajectory that can be used by a connected and autonomous vehicle in navigating the pavement segment takes place subsequent to collection of location data.

14. The process of claim 3, wherein the calculating does not use data from an imager.

15. A process for representing a location of a pavement segment, comprising:
a) Receiving, by a data collection system, location data from a GNSS module and at least one of a real-time kinetic system, an inertial measurement unit, an inertial navigation system, a total station system, an accelerometer, a gyroscope, or a rotary encoder;
b) using the location data, calculating a location of a pavement segment alignment module;
c) using the location of the pavement segment alignment module, calculating a location of the pavement segment using a Bayesian model-based filter;
d) using the location of the pavement segment, calculating, using non-Euclidean geometry, a polynomial representation of a trajectory that can be used by a connected and autonomous vehicle in navigating the pavement segment;
e) aligning the pavement segment alignment module with a pavement segment;
f) activating the data collection system to initiate calculation of the location of the pavement segment and of the polynomial representation of a trajectory that can be used by a connected and autonomous vehicle in navigating the pavement segment; and,
g) transmitting at least one of the location of the pavement segment and the polynomial representation of a navigation trajectory to non-transitory computer-readable storage media.

16. The process of claim 15, wherein the pavement segment is located in a work zone of a roadway.

17. A process for navigating a connected and autonomous vehicle along a pavement segment, comprising:
a) transmitting a signal to which a navigation system on the connected and autonomous vehicle responds by comparing version information for trajectory data for navigating the pavement segment stored in the navigation system, to version information for trajectory data for navigating the pavement segment contained in the signal;
b) if the comparing of version information indicates that a version of trajectory data provided in the signal is more recent than a version of trajectory data stored in the navigation system, providing the navigation system with updated trajectory data corresponding to the version information contained in the signal; and,
c) using the updated trajectory data to navigate the connected and autonomous vehicle along the pavement segment.

18. The process of claim 17, wherein the updated trajectory data is processed by the navigation system for autonomous navigation.

19. The process of claim 18, wherein the navigation system receives real-time navigation data from sensors on the connected and autonomous vehicle, compares the real-time navigation data with the updated trajectory data, and uses the real-time navigation data to change a trajectory of the connected and autonomous vehicle in accordance with the updated trajectory data.

20. The process of claim 19, wherein the connected and autonomous vehicle transmits the real-time navigation data to non-transitory computer-readable storage media remote from the connected and autonomous vehicle.

21. The process of claim 17, wherein the updated trajectory data is processed to generate a heads-up display provided on a windshield of the connected and autonomous vehicle.
